(19) United States
(12) Patent Application Publication
(10) Pub. No.: US 2005/0259959 A1
(43) Pub. Date: Nov. 24, 2005

(54) Media data play apparatus and system

(75) Inventors: Manabu Nagao, Tokyo (JP); Kohei Momosaki, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/129,381

(22) Filed: May 16, 2005

(30) Foreign Application Priority Data
May 19, 2004 (JP) P2004-149505

(51) Int. Cl. H04N 5/783

(52) U.S. Cl. 386/69; 386/96

(57) ABSTRACT

A media data memory stores media data including at least one of speech data and image data both playable in time series. A play control display unit displays a plurality of time figures. Each time figure corresponds to a play time of a part of the media data in time series order. A data selection unit selects at least one time figure from the plurality of time figures through the play control display unit. A play control unit moves a play position to a part of the play time corresponding to the at least one time figure in the media data. A play unit plays the media data from the play position moved by the play control unit.

### CROSS-REFERENCE TO RELATED APPLICATIONS

This application is based upon and claims the benefit of priority from prior Japanese Patent Application P2004-149505, filed on May 19, 2004; the entire contents of which are incorporated herein by reference.

### FIELD OF THE INVENTION

The present invention relates to a media data play apparatus and a system for controlling play of media data such as speech and video changing with passage of time.

### BACKGROUND OF THE INVENTION

In general, media data such as video data and audio data changing by passage of time is provided recorded in a record medium such as a CD-ROM, a DVD, a hard disk, a flash memory, or a video tape. In case of reading and playing the media data, in addition to play from the beginning, a user's desired position to play is located on the media data, and the media data is played from the desired position as an intermediate position of the media data. In this case, by a play control interface such as a remote controller or a play interface screen of a media data play apparatus, a user moves a play position to his/her desired position of the media data using a fast forward button and a rewind button, and the media data is played from the desired position. If the play position is not the desired position, the user further repeats the retrieval operation of the desired position using the fast forward button or the rewind button.

This retrieval operation of the desired position is very troublesome for the user. Accordingly, in a known video system, an operation area called a slider is set on a play control interface screen. By moving a button in the operation area, a play position is controlled. In this way, the user can easily operate fast forward, rewind, and play to retrieve the desired play position. This video providing system is disclosed in Japanese Patent Disclosure (Kokai) PH11-127420.

However, in this prior art, an operation area indicated by the slider is limited on play control interface screen. In case of media data with a long play back time, the entire play time of the media data must be assigned to the small area of the slider. Accordingly, in case of retrieving a desired play position, time accuracy of retrieval position is low. As a result, the user can not easily retrieve his/her desired play position in media data.

Furthermore, in general, a method for finding a user's desired play position from media data without playing is also known. In this method, a static image is extracted every predetermined segment from a dynamic image of video data. Each static image is reduced and arranged as an index of each segment of the video data. This technique is called a thumbnail display.

However, in the thumbnail display, each static image is too small for a user to watch. Accordingly, the user can not decide whether the static image is the desired play position. As a result, the user can not easily retrieve the desired play position from media data.

Especially, in case that the media data is audio data recording speech data, the user can not visually retrieve a play position. Accordingly, the user can not decide whether the indicated play position is the desired play position except for actual play of the audio data.

### SUMMARY OF THE INVENTION

The present invention is directed to a media data play apparatus and system for easily retrieve a user's desired play position of media data with high accuracy.

According to an aspect of the present invention, there is provided an apparatus for playing media data, comprising: a media data memory configured to store media data playable in time series, the media data including at least one of speech data and image data; a play control display unit configured to display a plurality of time figures, each time figure corresponding to a play time of a part of the media data in time series order; a data selection unit configured to select at least one time figure from the plurality of time figures through said play control display unit; a play control unit configured to move a play position to a part of the play time corresponding to the at least one time figure in the media data; and a play unit configured to play the media data from the play position moved by said play control unit.

According to another aspect of the present invention, there is also provided a system comprising a media data play apparatus for playing media data and a remote control apparatus for controlling play of said media data play apparatus through a network, the media data being playable in time series and including at least one of speech data and video data, said remote control apparatus comprising: a play control display unit configured to display a plurality of time figures, each time figure corresponding to a play time of a part of the media data in time series order; a data selection unit configured to select at least one time figure from the plurality of time figures through said play control display unit; a play control unit configured to generate play control indication data that a play position is moved to a part of the play time corresponding to the at least one time figure in the media data; and a communication unit configured to send the play control indication data to said media data play apparatus, and said media data play apparatus comprising: a communication unit configured to receive the play control indication data from said remote control apparatus; and a play unit configured to play the media data from the part indicated by the play control indication data.

According to still another aspect of the present invention, there is also provided a computer program product, comprising: a computer readable program code embodied in said product for causing a computer to play media data, said computer readable program code comprising: a first program code to store media data in a memory, the media data being playable in time series and including at least one of speech data and image data; a second program code to display a plurality of time figures on a display, each time figure corresponding to a play time of a part of the media data in time series order; a third program code to select at least one time figure from the plurality of time figures on the display; a fourth program code to move a play position to a part of the play time corresponding to the at least one time figure in the media data; and a fifth program code to play the media data from the moved play position.

### BRIEF DESCRIPTION OF THE DRAWINGS

FIG. 1 is a block diagram of a media data play apparatus according to a first embodiment.

FIG. 2 is a block diagram of a play control interface according to the first embodiment.

FIG. 3 is a hardware component of the media data play apparatus according to the first embodiment.

FIG. 4 is a schematic diagram of a play control screen of the media data play apparatus according to the first embodiment.

FIG. 5 is a schematic diagram of one example of the play control screen according to the first embodiment.

FIG. 6 is a schematic diagram of one example of time data according to the first embodiment.

FIG. 7 is a schematic diagram of one example of play control data according to the first embodiment.

FIG. 8 is a schematic diagram of one example of a speech segment database according to the first embodiment.

FIGS. 9A and 9B are schematic diagrams of examples of a speaker database and a text database according to the first embodiment.

FIGS. 10A and 10B are block diagrams of examples of a face database and a scene change database according to the first embodiment.

FIG. 11 is a flow chart of feature extraction processing of audio according to the first embodiment.

FIG. 12 is a flow chart of feature extraction processing of video according to the first embodiment.

FIG. 13 is a flow chart of play control processing according to the first embodiment.

FIG. 14 is a flow chart of figure drawing processing according to the first embodiment.

FIG. 15 is a schematic diagram of one example of feature figures with a balloon area according to the first embodiment.

FIG. 16 is a flow chart of a balloon area display processing according to the first embodiment.

FIG. 17 is a flow chart of play processing of media data according to the first embodiment.

FIG. 18 is a flow chart of figure selection processing according to the first embodiment.

FIG. 19 is a flow chart of repeat play processing according to the first embodiment.

FIG. 20 is a flow chart of scroll bar move processing according to the first embodiment.

FIG. 21 is a flow chart of memory processing of play control data according to the first embodiment.

FIG. 22 is a flow chart of play position control processing according to the first embodiment.

FIG. 23 is a schematic diagram of one example of the play control screen according to a second embodiment.

FIG. 24 is a flow chart of figure drawing processing according to the second embodiment.

FIG. 25 is a block diagram of the media data play apparatus according to a third embodiment.

FIG. 26 is a block diagram of the media data play apparatus according to a fourth embodiment.

FIG. 27 is a flow chart of figure drawing processing according to the fourth embodiment.

FIG. 28 is a block diagram of the media data play apparatus according to a fifth embodiment.

FIG. 29 is a flow chart of figure drawing processing according to the fifth embodiment.

FIG. 30 is a block diagram of a media data play system according to a sixth embodiment.

FIG. 31 is a schematic diagram of hardware component of a remote control apparatus and a media data play apparatus according to the sixth embodiment.

FIG. 32 is a schematic diagram of a play control screen of the remote operation apparatus according to the sixth embodiment.

FIG. 33 is a schematic diagram of the play control screen of a cellular-phone as the remote control apparatus according to the sixth embodiment.

FIG. 34 is a flow chart of figure drawing processing of the remote control apparatus according to the sixth embodiment.

FIG. 35 is a flow chart of feature data retrieval processing of the media data play apparatus according to the sixth embodiment.

FIG. 36 is a block diagram of the media data play system without a feature data extraction unit and a feature data storage unit according to the sixth embodiment.

### DETAILED DESCRIPTION OF THE EMBODIMENTS

Hereinafter, various embodiments of the present invention will be explained by referring to the drawings. In a media data play apparatus of a first embodiment, a plurality of time figures each representing a play time (position) of media data are arranged in time series on an area of a play control screen. Furthermore, feature data of each play time is extracted from the media data, and a feature figure representing the feature data is correspondingly displayed on the time figure. When a user indicates a desired time figure, a play position is moved to a position of the play time of the indicated time figure, and the media data is played from the position.

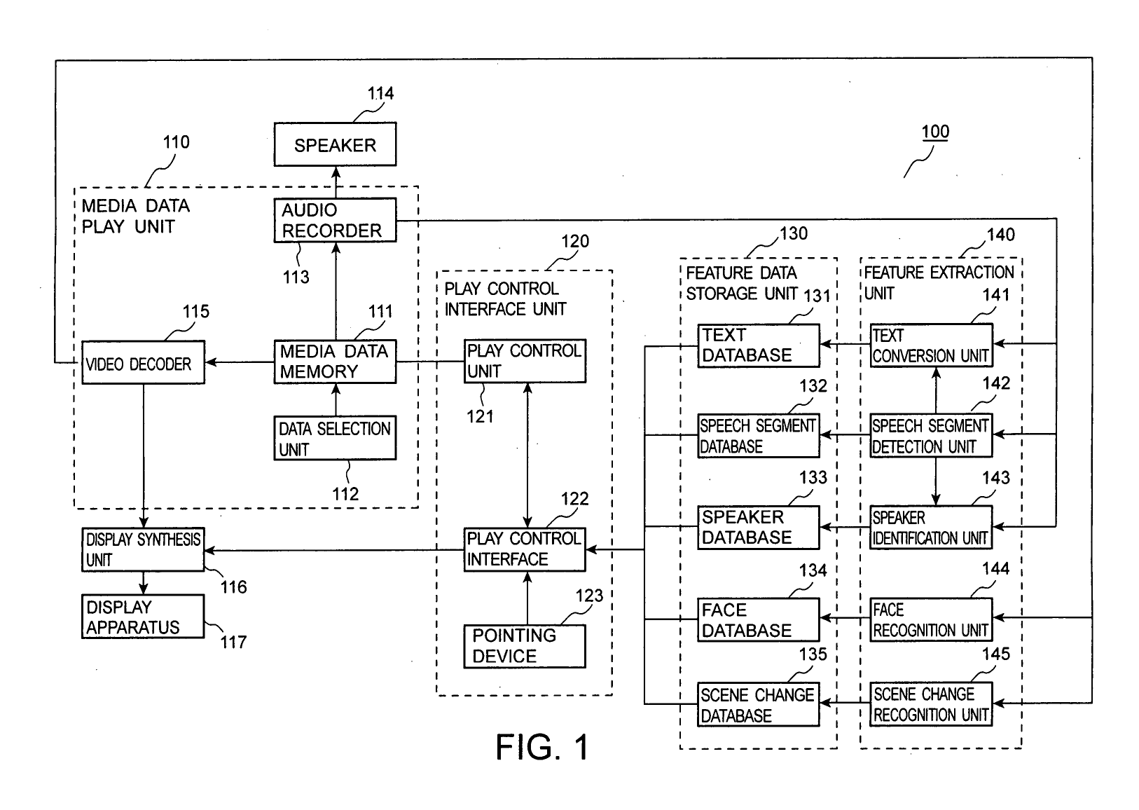

FIG. 1 is a block diagram of the media data play apparatus according to the first embodiment. In FIG. 1, arrows represent data flow. As shown in FIG. 1, the media data play apparatus includes a media data play unit 110, a play control interface unit 120, a feature data storage unit 130, and a feature extraction unit 140. The media data play unit 110 is connected to a speaker 114, and a display apparatus 117 through a display synthesis unit 116.

The media data play unit 110 stores media data and executes play processing of the media data. The media data play unit 110 includes a media data memory 111, a data selection unit 112, an audio decoder 113 and a video decoder 115.

The media data memory 111 is, for example, an optical memory such as a CD or CD-ROM, a hard disk, a solid state memory such as a flash memory, or a video tape and stores at least one media data. The media data includes speech data and image data, each of which have contents that change with the passage of time, which is called time series media data. The media data is related with a unique name (For example, a file name) in the media data memory 111. In case of a user's retrieval and selection of media data, the unique name is displayed on the display apparatus 117.

The data selection unit 112 retrieves media data stored in the media data memory 111 and selects the media data to be played in response to a user's indication. For example, in case of the media data play apparatus 100 as PC (Personal Computer), media data is stored by unit of file in a hard disk drive (HDD) as the media data memory 111 managed by a file system. Operation by the data selection unit 112 corresponds to selection operation of a file. Furthermore, for example, in case of the media data play apparatus 100 as a video deck, operation by the data selection unit 112 corresponds to insertion operation of a video tape. The user selects media data to be played by the data selection unit 112.

The audio decoder 113 converts speech data in media data to audio data. The speaker outputs the audio data converted by the audio decoder 113.

The video decoder 115 converts image data in media data to video data. The display synthesis unit 116 synthesizes video data (received from the video decoder 115) with data of time figure and feature figure (received from the play control interface).

The display apparatus 117 is, for example, a display and outputs video data synthesized by the display synthesis unit 116.

The play control interface unit 120 executes play control of media data, and mainly includes a play control unit 121, a play control interface 122 and a pointing device 123.

The play control unit 121 executes play of media data from a play position indicated by the play control interface 122.

The play control interface 122 executes display processing of various figures (time figure, feature figure, control figure) related to play control on the display apparatus. Furthermore, the play control interface 122 receives an event of a time figure indicated by the pointing device 123 from the user and moves a play position of media data to a position of play time corresponding to the time figure.

The pointing device is an input apparatus such as a mouse, a tablet, or a touch panel.

The feature data storage unit 130 is, for example, a memory medium such as a HDD or a memory, and includes a speech segment database 132, a speaker database 133, a face database 134, and a scene change database 135.

The feature extraction unit 140 extracts feature of each time of media data and stores the feature in the feature data storage unit 130. The feature extraction unit 140 includes a text conversion unit 141, a speech segment detection unit 142, a speaker identification unit 143, a face recognition unit 144, and a scene change recognition unit 145.

The text conversion unit 141 receives speech segment data from the speech segment detection unit 142 and audio data from the audio decoder 113, converts the audio data in a speech segment to text data, and registers the text data in the text database 131. A known speech recognition technique may be utilized for this conversion. In the text data, a start time and an end time are related by unit of a character, a word, or a sentence.

The speech segment detection unit 142 decides whether speech is included in audio data received from the audio decoder 113. In case of including speech, the speech segment detection unit 142 registers speech segment data as an inclusion segment (start time and end time) of speech of audio data in the speech segment database 132.

The speaker identification unit 143 receives speech segment data from the speech segment detection unit 142 and audio data from the audio decoder 113, identifies a speaker from the audio data in a speech segment, generates speaker data, and registers the speaker data in the speaker database 133. The speaker data includes an identification number (ID) of a speaker, and a start time and an end time of the speech segment obtained by the speech segment detection unit 142.

The face recognition unit 144 decides whether a person's face is included in video data received from the video decoder 115. In case of including a person's face, the face recognition unit 144 identifies the person of the face, and registers face existence segment data as a period (start time and end time) including the face in the face database 134. Furthermore, in case of identifying the person, a face ID specifying the person's face is corresponded with the start time and the end time in the face existence segment data.

The scene change recognition unit 145 decides a time of scene change from video data (received from the video decoder 115), generates scene change data representing time data when scene change occurs in the video data, and registers the scene change data in the scene change database 135.

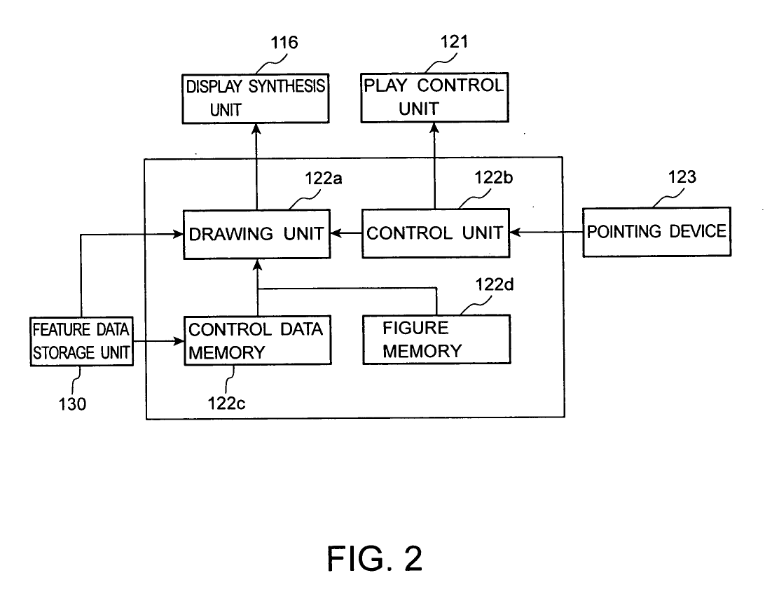

Next, the play control interface 122 of the play control interface unit 120 is explained. FIG. 2 is a block diagram of the play control interface 122. As shown in FIG. 2, the play control interface 122 includes a drawing unit 122a, a control unit 122b, a control data memory 122c, and a figure memory 122d.

The figure memory 122d previously stores drawing data of a time figure, a feature figure and a control figure. The figure memory 122d may be a memory such as ROM (Read Only Memory), or RAM (Random Access Memory), or HDD.

The control data memory 122c stores time data of the time figure corresponded with a play time, and play control data of a repeat play or a jump. The control data memory 122c may be a memory such as RAM or HDD.

The drawing unit 122a sends figure data of the time figure, the feature figure, and the control figure to the display synthesis unit 116, and executes drawing processing for the display apparatus 117.

The control unit 122b receives an event of time figure from the pointing device 123 in response to a user's indication, and controls the play control interface 122.

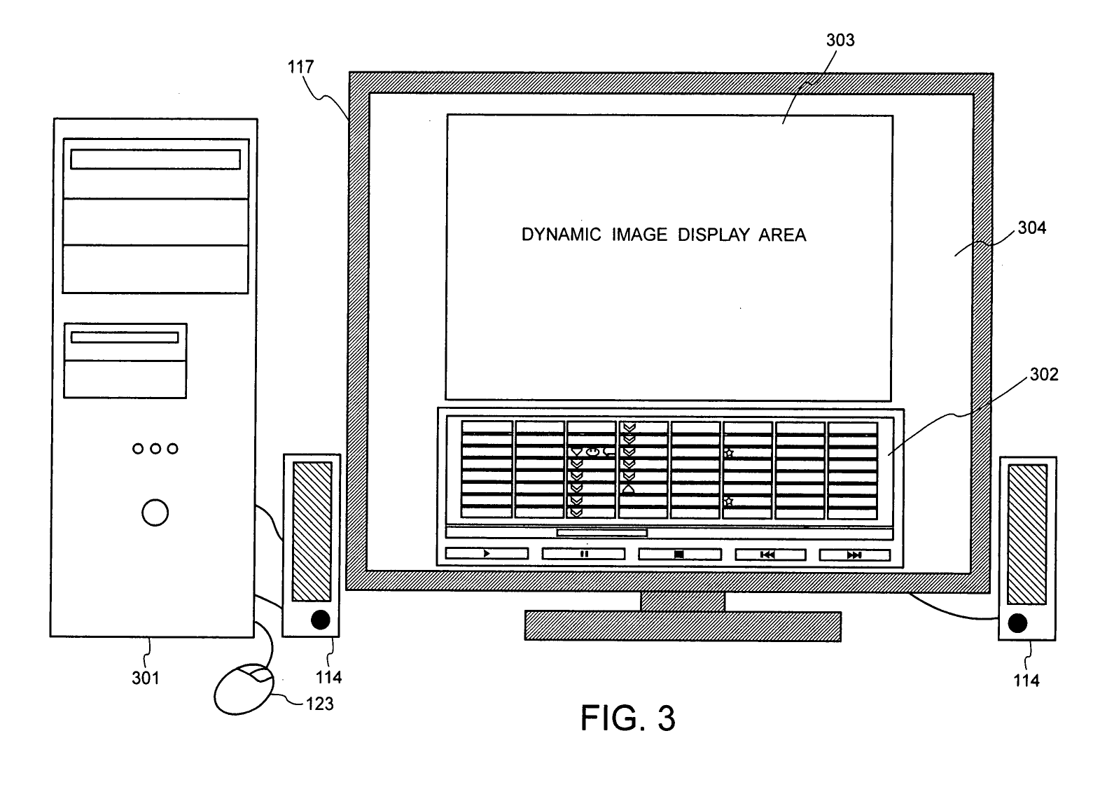

Next, hardware components of the media data play apparatus 100 are explained. FIG. 3 is a schematic diagram of hardware components of the media data play apparatus 100. In the media data play apparatus 100 of the first embodiment, a main body unit 301 includes a control apparatus such as CPU, a memory apparatus such as ROM or RAM, and an outside memory apparatus such as HDD, CD drive apparatus, or DVD drive apparatus. Furthermore, the media data play apparatus 100 includes a display apparatus 117 such as a display, an input apparatus such as a keyboard or a pointing device 123 (mouse), and a speech output apparatus such as speakers 114. Briefly, the media data play apparatus 100 is a hardware component using a typical computer.

In case of media data as video, a dynamic image is displayed on a dynamic image display area 303 of a screen 304 in the display apparatus 117. Furthermore, a play control screen 302 is displayed on the lower side of the dynamic image display area 303. Furthermore, in case of media data as speech, the play control screen 302 is only displayed on the screen 304. As shown in FIG. 3, the display synthesis unit 116 displays the screen 304 by synthesizing the dynamic image display area 303 with the play control screen 302.

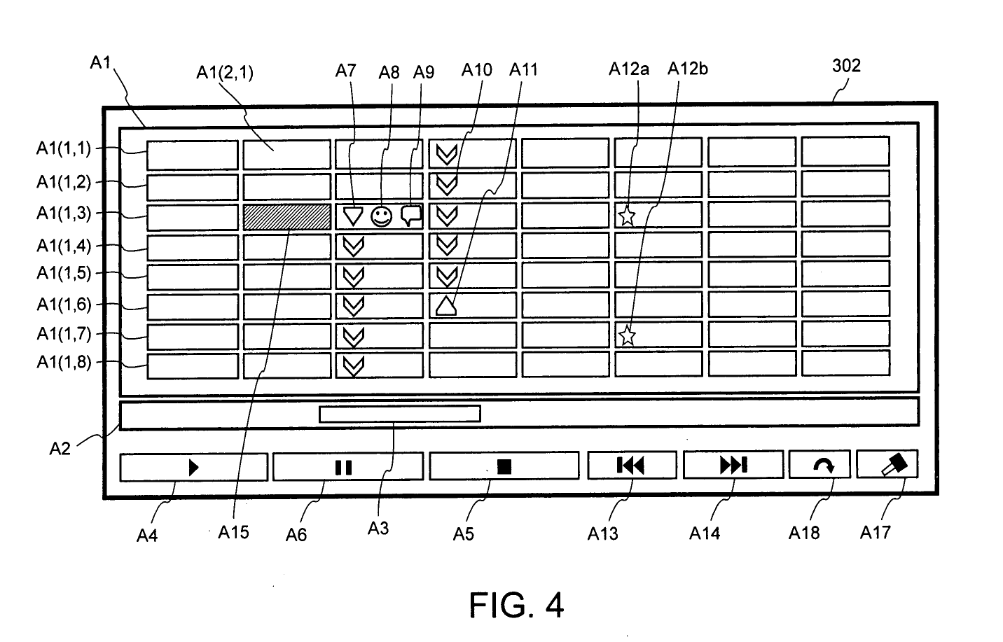

Next, the play control screen 302 is explained. FIG. 4 is one example of the play control screen 302 displayed in the media data play apparatus 100.

As shown in FIG. 4, time figures A1(1,1), A1(1,2), . . . A1(1,8), A1(2,1), . . . , are arranged in two-dimensional rectangle area A1 of the play control screen 302. Furthermore, feature figures A7, A8, A10, and A11 each representing a feature of media data, a balloon figure A9, and control figures A12a and A12b are overlap-displayed on the time figures. Furthermore, a current position figure A15 is displayed. The number of time figures and the arrangement shape of time figures on the rectangle shape A1 are not limited to FIG. 1.

Furthermore, a scroll bar A3 is displayed on the play control screen 302. A left side position of the scroll bar A3 is a play start position of media data selected, and a right side position of the scroll bar A3 is a play end position of media data selected. The scroll bar A3 is moved by operation of drag and drop, and movable in limit of a scroll area A2.

The left side position of the scroll bar A3 is a position of the earliest play start time among play start times related with time figures displayed on the area A1. The right side position of the scroll bar A3 is a position of the latest play end time among play end times related with time figures displayed on the area A1.

In the play control screen 302, a play button A4, a stop button A5, a temporary stop button A6, move buttons A13 and A14, and setup buttons A17 and A18 are displayed.

The play button A4 starts a play of media data. The stop button A5 stops a play of media data. The pause button A6 temporarily stops a play of media data. The move button A13 moves a play position to a position related with a control figure as a jump position of play time earlier than a current play time. The move button A14 moves a play position to a position related with a control figure as a jump position of play time later than a current play time. The setup button A17 displays a play control setup screen (explained afterward).

By using the pointing device 123 on the play control screen 302, a user can control a play of media data through the play control unit 121.

Next, each figure displayed on the play control screen 302 is explained. The time figure is assigned to a play start time and a play end time. The current position figure represents a current play position of media data, and is displayed on a time figure of play time including the current play time (position). By referring to the current position figure, a user can know the current play position of media data.

The feature figure represents each features of media data. By referring to the feature figure, a user can know at least one feature of each play time of media data, and easily operate retrieval of a desired play position.

The control figure is set by a user through the pointing device 123. For example, the control figure represents a repeat segment, a function of book mark, or a jump position of play position.

The feature figure often functions in the same way as the control figure. For example, if a user wants to play a speech segment only, the user sets a feature figure representing the speech segment as a control figure representing a jump position. In this case, the speech segment is played by skipping non-speech segments.

Furthermore, if the user wants to repeatedly play the speech segment, by setting the speech segment as a repeat segment, the speech segment can be repeatedly played. In this case, a play start position of the speech segment is a start position of the repeat segment, and a play end position of the speech segment is an end position of the repeat segment.

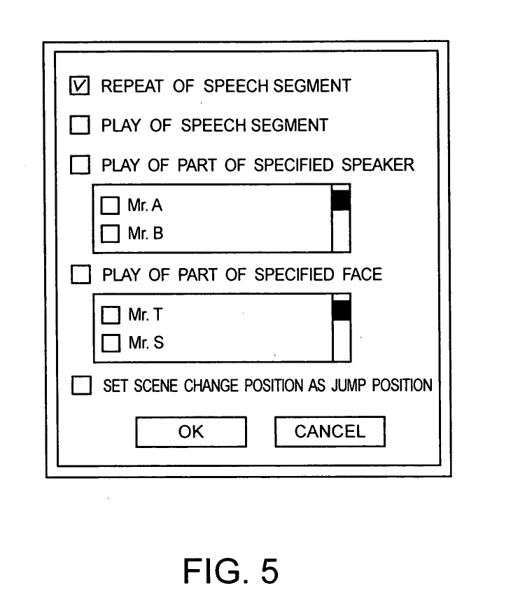

The control figure is set through a play control setup screen displayed by the setup button A17 on the play control screen 302. FIG. 5 is one example of the play control setup screen. As shown in FIG. 5, a user checks a checkbox of each item on the play control setup screen. Selected contents of the check box are input to the play control interface 122, and the play control interface 122 executes play control based on the selected contents.

Each figure is not limited to a shape shown in FIG. 4, and may be any shape. For example, if a time figure is too small and if the display apparatus 117 can display in color, the time figure, the current position figure, the feature figure and the control figure may be same shape with different colors. For example, in case of using speech segment data as feature data, a color of the time figure is white while a color of the feature figure is red in order to discriminate each figure. Furthermore, if a color of the current position figure is green and if a user wants to view speech only, the user selects the red feature figure with the pointing device 123. In this case, the user can decide whether the selected position is played by referring to the current position figure of green.

Furthermore, if the display apparatus 117 can display in monochrome only, each figure is displayed with hatching in order to discriminate each figure. In FIG. 4, the current position FIG. A15 is displayed with hatching.

Next, relation between a time figure and a play time is explained. Each time figure is corresponded with a play start time (start position) and a play end time (end position) of media data. The play start time and the play end time are called time data. The time data is stored in the control data memory 122c of the play control interface 122.

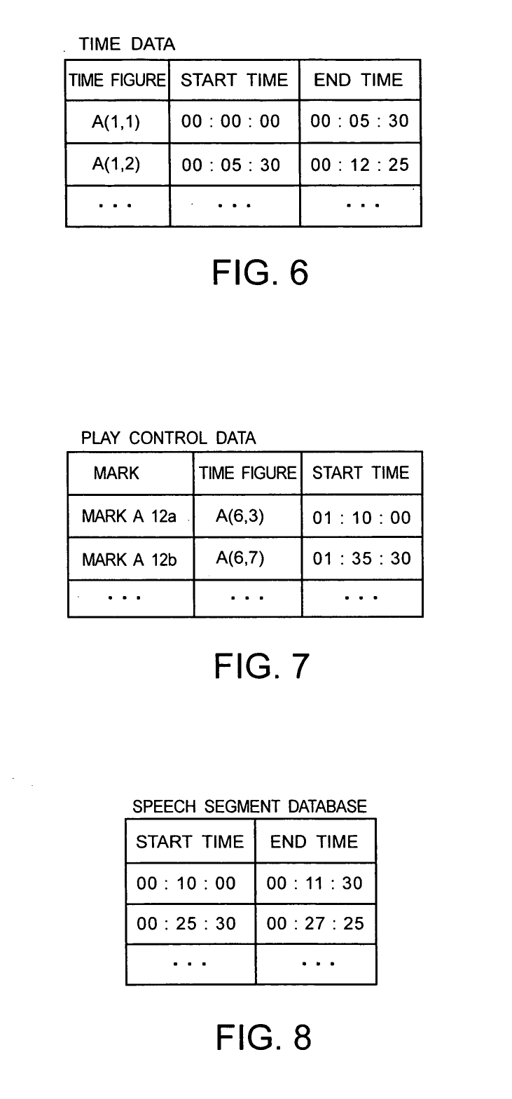

FIG. 6 is one example of time data. As shown in FIG. 6, a time figure, a start time (play start position), and an end time (play end position) of the time figure in media data are corresponded.

Next, play control data is explained. When a user sets play control such as a repeat play or a jump position on the play control screen 302, the play control interface 122 generates play control data and stores the play control data in the control data memory 122c.

FIG. 7 is one example of play control data. As shown in FIG. 7, mark data of a mark set by a user on a time figure of the play control screen 302, an identifier of the time figure, and a start time of the time figure are corresponded. The identifier of the time figure is retrieved by the start time of FIG. 7 and time data of FIG. 6. Accordingly, the identifier of time figure may be omitted. The mark data discriminates a mark clicked on a time figure in case that a user clicks a marking button (For example, a right button of a mouse) on the time figure by using the pointing device 123. Click of the marking button assigns a predetermined function to the time figure.

Next, each database stored in the feature data storage unit 130 is explained.

The speech segment database 132 registers speech segment data recoding a speech segment detected from speech data (audio data) of media data. FIG. 8 is one example of data component of the speech segment database. As shown in FIG. 8, a start time and an end time are corresponded as the speech segment data.

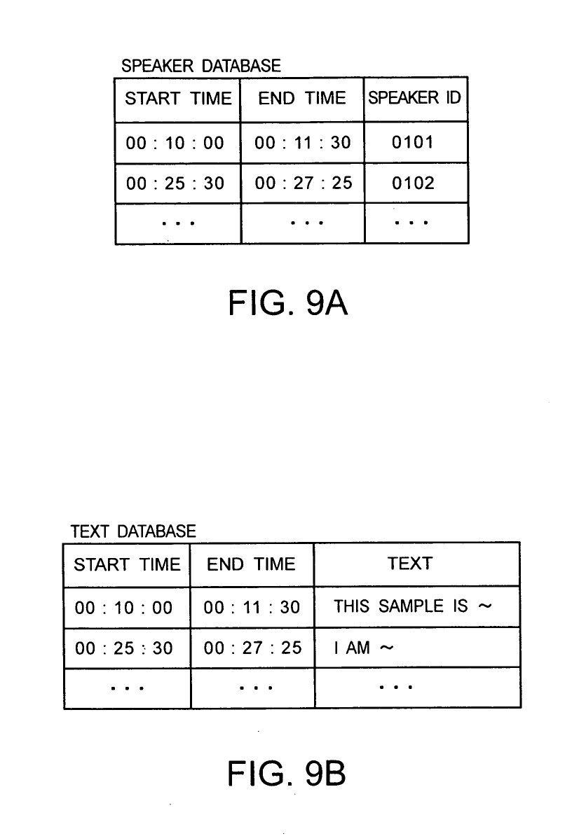

The speaker database 133 registers speaker data including a speaker ID (identifier of a speaker who uttered a speech) and a speech segment of the speech. FIG. 9A is one example of data components of the speaker database 133. As shown in FIG. 9A, a start time and an end time of the speech segment, and the speaker ID are corresponded as the speaker data.

The text database 131 registers text data converted from speech data and a speech segment including the speech data. FIG. 9B is one example of data components of the text database 131. As shown in FIG. 9B, a start time and an end time of the speech segment, and a text as utterance contents are corresponded as the text data.

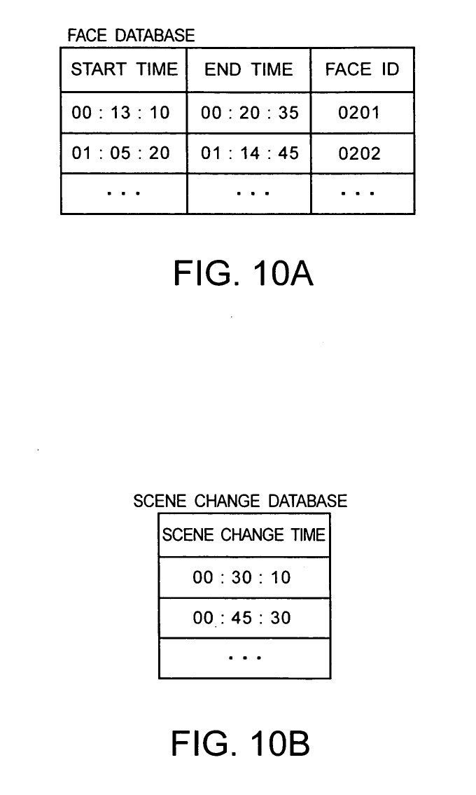

The face database 134 registers face segment data including a segment of a person's face in video data of media data and a face ID (identifier of the person's face). FIG. 10A is one example of data component of the face database 134. As shown in FIG. 10A, a start time and an end time of the segment including the person's face and the face ID are corresponded as the face segment data.

The scene change database 135 registers a time of scene change in video data of media data. FIG. 10B is one example of data component of the scene change database 135. As shown in FIG. 10B, a scene change time representing a time when contents of video data changes in media data is registered.

Next, play processing of media data in the media data play apparatus 100 is explained. First, extraction processing of feature data from media data by the feature processing unit 140 is explained.

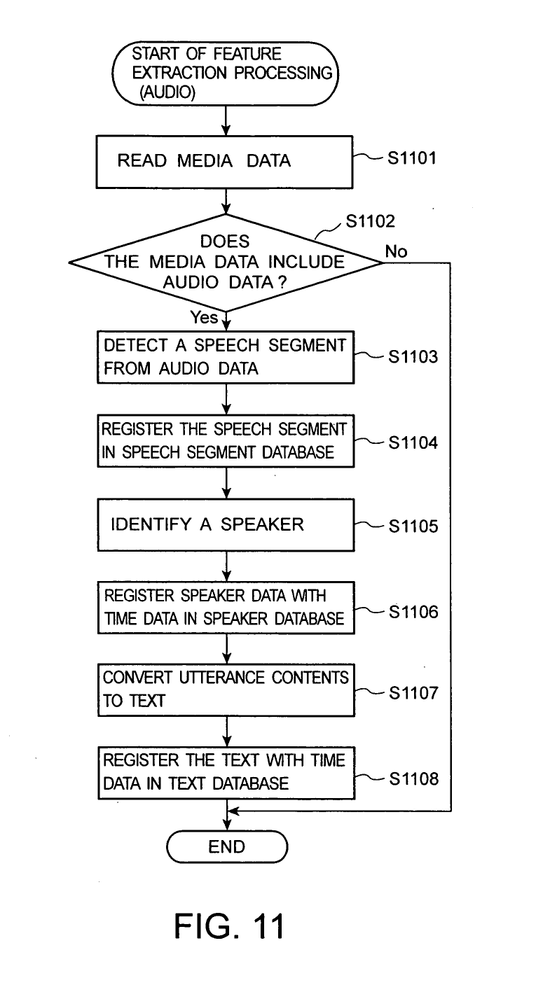

FIG. 11 is a flow chart of extraction processing of feature data from audio data of media data by the feature extraction unit 140.

When a user indicates media data to be played, the data selection unit 112 reads indicated media data from the media data memory 111 (S1101). The audio decoder 113 decides whether the media data includes audio data (S1102). In case of not including audio data (No at S1102), processing is completed.

In case of including audio data (Yes at S1102), the audio decoder 113 converts data (received from the media data memory 111) to audio data, and the speech segment detection unit 142 decides whether the audio data includes speech. In case of including speech, the speech segment detection unit 142 detects a speech segment as a start time and an end time of the speech (S1103). The speech segment detection unit 142 registers the speech segment as speech segment data in the speech segment database 132 as shown in FIG. 8 (S1104).

Next, the speaker identification unit 143 identifies a speaker who uttered a speech of audio data in the speech segment (S1105). As shown in FIG. 9A, the speaker identification unit 143 registers the speaker ID, the start time, and the end time of the speech segment as speaker data in the speaker database 133 (S1106).

Next, the text conversion unit 141 converts utterance contents of speech of audio data in the speech segment to text (S1107). As shown in FIG. 9B, the text conversion unit 141 registers the text, a start time, and an end time of the speech segment as text data in the text database 131 (S1108). In this case, the text is data of a character unit, a word unit, or a sentence unit.

In this way, speech segment data, speaker data and text data as feature data are extracted from audio data in media data. Each data are respectively registered in the speech segment database 132, the speaker database 133, and the text database 131.

In addition to this, detection whether audio data includes sound, detection whether audio data includes music, detection whether audio data includes a large number of noises, detection whether audio data includes a predetermined effect sound, and discrimination between male/female speakers may be executed, and respectively registered in each database. Furthermore, the play control interface 122 may display each feature as a unique feature figure.

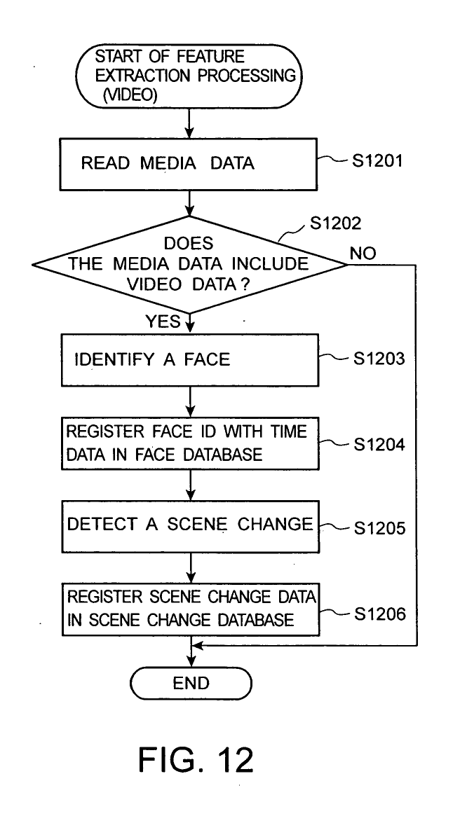

Next, extraction processing of feature data from video data of media data is explained. FIG. 12 is a flow chart of extraction processing of feature data from video data of media data.

When a user indicates media data to be played, the data selection unit 112 reads indicated media data from the media data memory 111 (S1201). The video decoder 115 decides whether the media data includes video data (S1202). In case of not including video data (No at S1202), processing is completed.

In case of including video data (Yes at S1202), the video decoder 115 converts data (received from the media data memory 111) to video data, and the face recognition unit 144 decides whether the video data includes a face image of a person. In case of including the face image, the face recognition unit 144 identifies a person of the face image (S1203). The face image recognition unit 144 registers a face ID of the identified person, a start time, and an end time of a segment including the face image in the face database 134 as shown in FIG. 10A (S1204).

Next, the scene change recognition unit 145 detects a time of scene change from video data (S1205). The scene change recognition unit 145 registers time of scene change as scene change data in the scene change database 135 as shown in FIG. 10B (S1206).

In this way, face segment data and scene change data as feature data are extracted from video data of media data, and respectively registered in the face database 134 and the scene change database 135.

In addition to this, detection whether video data includes a person, an animal, a vehicle, or a building, detection whether image includes change, conversion from characters to a text in case of including the characters in video data, or conversion from video of sign language to a text of the sign language, may be executed, and respectively registered in each database. Furthermore, the play control interface 122 may display each feature as a unique feature figure.

In the first embodiment, feature data extraction processing is executed immediately after selecting media data. However, in case of displaying each feature figure on the play control screen 302, the user indicates the feature data extraction processing using the play control interface 122. For example, by clicking a setup button A18 as a feature data extraction button, the play control interface 122 may execute the feature data extraction processing.

Furthermore, after extracting features from media data, each feature data is stored in each database on the feature data storage unit 130. Accordingly, in case of selecting the same media data again, the feature data extraction processing need not be executed.

Next, play control processing of media data by the play control interface unit 120 is explained. In the play control processing, a time figure, a current position figure, a feature figure and a control figure are displayed on the play control screen 302. In response to a user's indication for each figure, a segment between two indicated figures in media data is played, and play control such as a repeat play or a jump is executed.

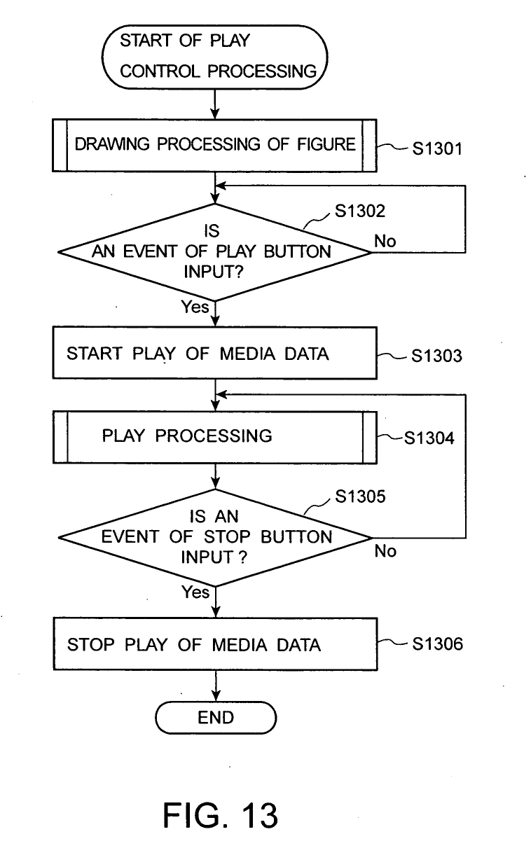

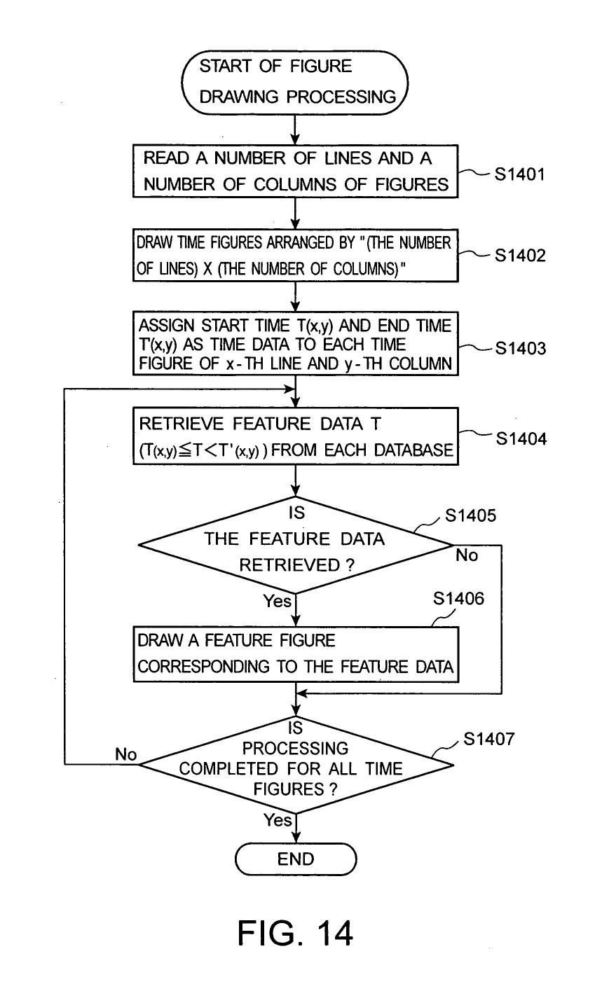

FIG. 13 is a flow chart of play control processing. First, the play control interface 122 draws a time figure, a current position figure, a feature figure and a control figure of media data on the play control screen 302 (S1301). In this case, the display synthesis unit 116 synthesizes an area A1 to display the time figure and the feature figure with a dynamic image on a dynamic display area, and figures synthesized with the dynamic image are drawn on the play control screen 302 as shown in FIG. 4. The drawing processing of figures is explained afterward.

Next, the play control interface 122 waits an event notification of a play button (S1302). In case of notifying an event of the play button (Yes at S1302), play of media data starts (S1303).

Concretely, the play control unit 121 sends an instruction to play media data selected by the data selection unit 112 to the media data memory 111. In response to the instruction, the media data memory 111 sends the selected media data to the video decoder 115 and the audio decoder 113. The audio decoder 113 converts the received data to audio data, and sends the audio data to the speaker 114. The speaker 114 plays the audio data. The video decoder 115 converts the received media data to video data, and sends the video data to the display synthesis unit 116. The display synthesis unit 116 synthesizes the video data with data received from the play control interface 122, and sends the synthesized data to the display apparatus 117.

The play control interface 122 executes play processing (S1304). The play processing is explained afterward. The play processing is executed until an event of a stop button A5 is notified (S1305). In case of notifying the event of the stop button A5, play of media data is stopped (S1306).

Next, figure drawing processing of S1301 is explained. FIG. 14 is a flow chart of the figure drawing processing. First, the drawing unit 122a of the play control interface 122 reads a number of lines and a number of columns of figures locatable in area A1 (S1401). The number of lines and the number of columns are preserved in the control data memory 122c of the play control interface 122 based on a size of the play control screen 302 of the display apparatus 117.

Next, the drawing unit 122a of the play control interface 122 draws time figures each representing a different play time (in time series) on the area A1 (S1402). The number of time figures is equal to “(the number of lines)×(the number of columns)”. In FIG. 4, the time figures are displayed as A1(1,1), A2(1,2), . . . , A1(1,8), A1(2,1), . . . . The control unit 122b of the play control interface 122 assigns a start time and an end time to each time figure. An identifier of the time figure, the start time, and the end time are stored as time data in the control data memory 122c (S1403). For example, the start time and the end time are assigned as follows.

Assume that a start time assigned to time figures A1(1,1), A1(1,2), . . . , A1(1,8) A1(2,1), . . . , is respectively T(1,1), T(1,2), . . . , T(1,8), T(2,1), . . . . In this case, the time figures are located in order as “T(1,1)<T(1,2)< . . . <T(1,8)<T(2,1)< . . . ”. Briefly, a start time is assigned to each time figure so that the start time increases from the upper side to the lower side on the area A1 and the start time increases from the left side to the right side on the area A1.

Assume that an end time of the time figure of m-th line and n-th column is T′(m,n), and assume that a start time T(x,y) and an end time T′(x,y) are assigned to a time figure of x-th line and y-th column (1≦x≦the number of lines, 1≦y≦the number of columns). In this case, the control unit 122b retrieves feature data (speech segment data, speaker data, text data, face segment data, scene change data) related with a time T (T(x,y)≦T≦T′ (x,y)) from the feature data storage unit 130 (speech segment database 132, speaker database 133, face database 134, scene 135)(S1404).

The control unit 122b decides whether the feature data is retrieved (S1405). In case of retrieving the feature data (Yes at S1405), the drawing unit 122a reads a feature figure corresponding to the retrieved feature data from the figure memory 122d, and displays the feature figure on a time figure of time T (S1406). On the other hand, in case of not retrieving the feature data, feature figure is not displayed on the time figure of time T.

This processing from S1404 to S1406 is executed for all time figures (S1407). In this way, the time figure and the feature figure (A7˜A11 in FIG. 4) are displayed in the area A1.

Furthermore, in case that the control data memory 122c of the play control interface 122 stores play control data, a control figure is displayed in the same way as the feature figure. In FIG. 4, control figures A12a and A12b are displayed.

The feature figure and the control figure are displayed on a time figure of corresponding time or around the time figure. In this case, the feature figure and the control figure are displayed with an overlap on a time figure so that they are not obscured by a time figure. Alternatively, they are displayed without overlap.

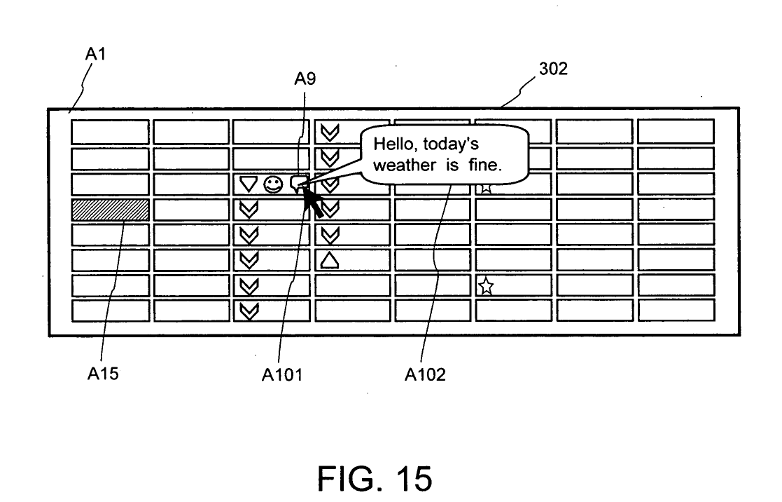

As mentioned-above, a time figure, a feature figure and a control figure are displayed. If a size of the time figure or a space between neighboring time figures is not sufficient to display the feature figure and the control figure, a balloon area as a supplement area is displayed in relation to the time figure, and the feature figure or the control figure is displayed in the balloon area. FIG. 15 is one display example of the balloon area with the feature figure. As shown in FIG. 15, a balloon figure A9 representing display of the feature figure (or the control figure) by a balloon area is displayed in the time figure. By moving a cursor (using pointing device 123) on the balloon figure A9, a balloon area A102 is displayed and a feature figure is displayed in the balloon area A102. In FIG. 15, text data read from the text database 131 is displayed in the balloon area A102.

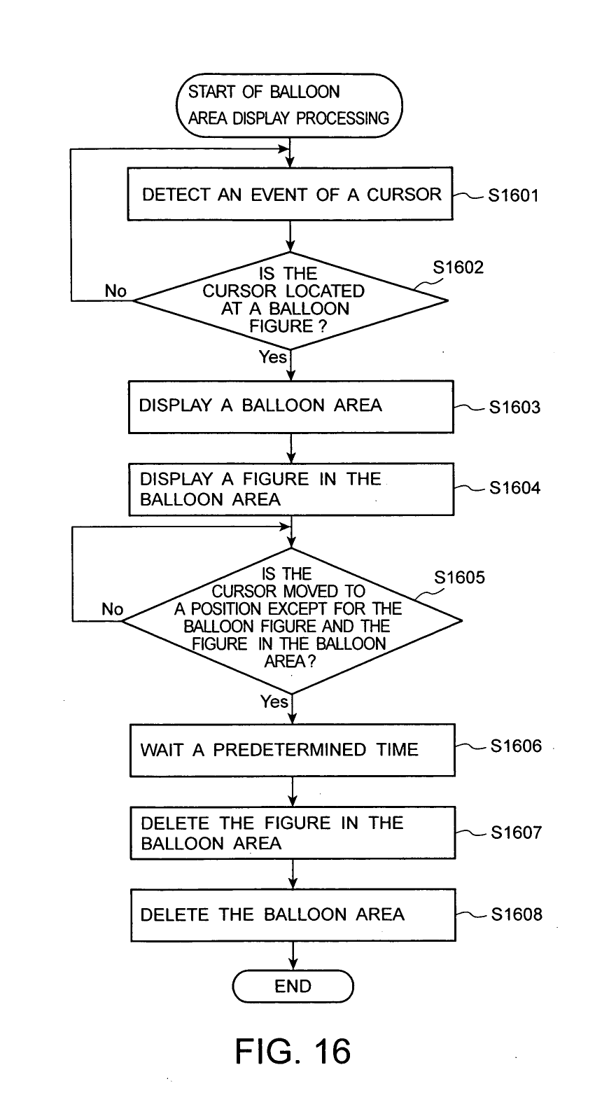

Next, display processing of the balloon area A102 is explained. FIG. 16 is a flow chart of the display processing of the balloon area A102. When the control unit 122b of the play control interface 122 detects an event of cursor (S1601), the control unit 122b decides whether a cursor locates at the balloon area A9 on the time figure from the event (S1602). In case that the cursor does not locate at the balloon area A9 (No at S1602), the control unit 122b waits an event notification.

On the other hand, in case that the cursor locates at the balloon area A9 (Yes at S1602), the drawing unit 122a displays a balloon area A102 (S1603). Next, the drawing unit 122a displays a feature figure or a control figure (not displayed on or around the time figure) in the balloon area A102.

This display processing is repeatedly executed until the control unit 122b decides that the cursor moves to a position except for the balloon figure A9 and a figure in the balloon area A102 (S1605).

In case that the control unit 122b decides that the cursor moves to a position except for the balloon figure A9 and a figure in the balloon area A102 (Yes at S1605), the control unit 122b waits a predetermined time (S1606), deletes the figure in the balloon area A102 after the predetermined time (S1607), and deletes the balloon area A102 (S1608).

In this way, a feature figure or a control figure not drawn on or around the time figure is drawn in the balloon area A102.

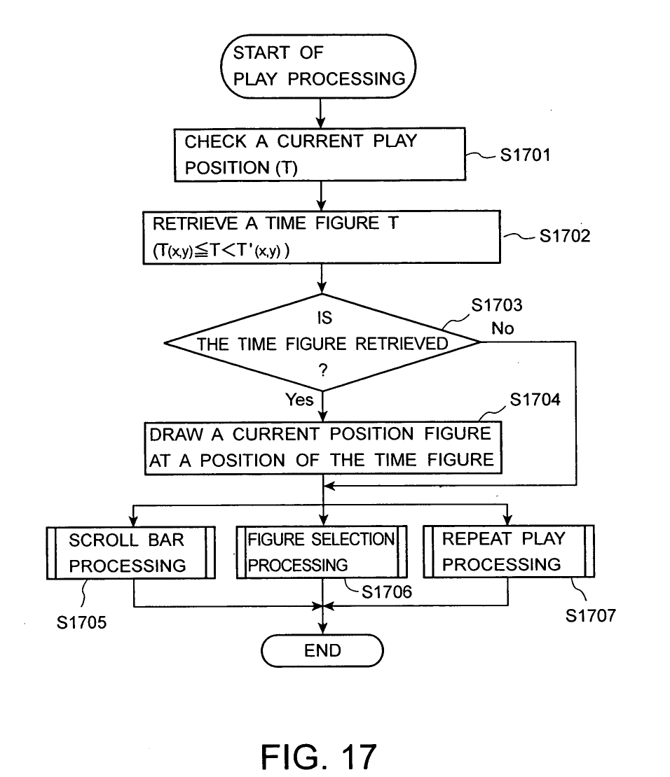

Next, play processing of media data at S1304 in FIG. 13 is explained. FIG. 17 is a flow chart of play processing of media data.

The play control unit 121 checks a current play position by obtaining a current play time (T) from the media data memory 111 (S1701). The play control interface 122 retrieves a time figure related with the time T(T(x,y)≦T≦T′(x,y)) (S1702) In case of retrieving the time figure (Yes at S1703), the drawing unit 122a obtains a current position figure from the figure memory 122d, obtains a display position (x,y) of the time figure, and the current position figure at the position (x,y) (S1704). On the other hand, in case of not retrieving the time figure (No at S1703), the current position figure is not drawn.

The current position figure is displayed on this side of the time figure (the feature figure, the control figure) in order not to be obscured by the time figure (the feature figure, the control figure).

Furthermore, if a current play position is not included in a limit of the area A1 between the start time and the end time, the current position figure is not displayed.

Next, in response to a user's operation through the play control screen 302, scroll bar processing (S1705), figure selection processing (S1706), and repeat processing (S1707) are selectively executed.

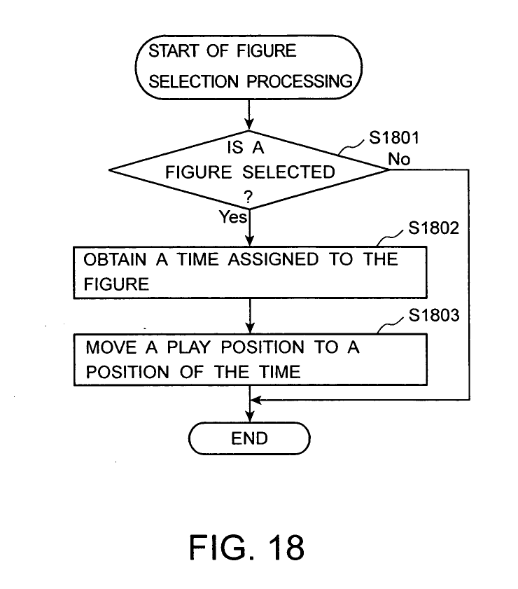

First, the figure selection processing (S1706) in FIG. 17 is explained. FIG. 18 is a flow chart of the figure selection processing. The control unit 122b of the play control interface 122 decides whether a time figure, a current position figure, a feature figure, or a control figure in area A1 of the play control screen 302 is selected by a user from an event notified by the pointing device 123 (S1801). If any figure is selected (Yes at S1801), the control unit 122b obtains a start time assigned to the selected figure by referring to the time data in the control data memory 122c (S1802). Next, the play control unit 121 moves a play position to a position of the start time (S1803). In this way, media data is played by moving the play position to the indicated position.

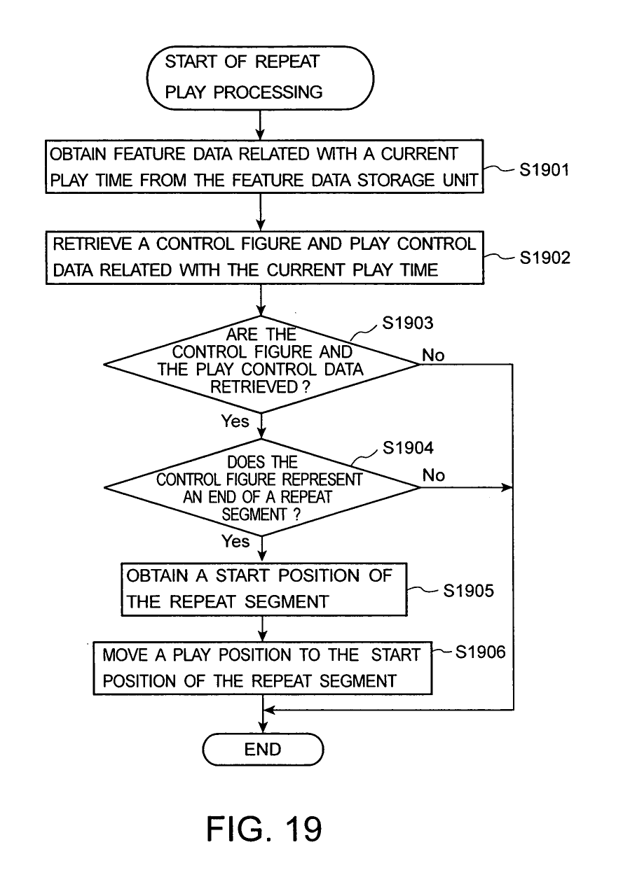

Next, the repeat play processing at S1707 in FIG. 17 is explained. FIG. 19 is a flow chart of the repeat play processing.

First, the play control unit 121 reads a current play time from the media data memory 111, and obtains feature data related with the current play time from the feature data storage unit 130 (S1901). Next, the play control unit 121 retrieves a control figure related with the current play time and play control data to display the control figure from the control data memory 122c (S1902). As a retrieval result, if the control figure and the play control data do not exist (No at S1903), processing is completed.

On the other hand, if the control figure and the play control data exist (Yes at S1903), the play control unit 121 decides whether the control figure represents an end of repeat segment (S1904). If the control figure does not represent the end of repeat segment (No at S1904), processing is completed.

If the control figure represents the end of repeat segment (Yes at S1904), it means that the current play time reaches the end time of the repeat segment. Accordingly, the play control unit 121 obtains a start time of the repeat segment from the play control data (S1905). Next, the play control unit 121 moves a play position of media data to a position of the start time (S1906). In this way, play of repeat segment is executed.

At S1901, as play control data representing a start position and an end position of the repeat segment, feature data stored in the feature data storage unit 130 is used. Accordingly, a feature figure can be used as a control figure.

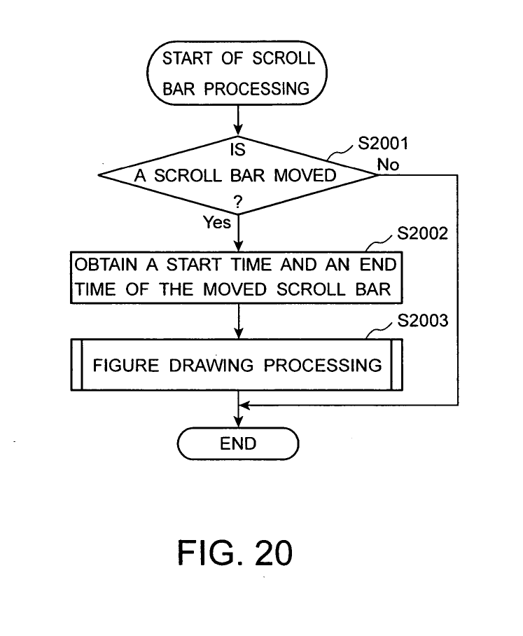

Next, scroll bar processing at S1705 in FIG. 17 is explained. FIG. 20 is a flow chart of the scroll bar processing.

The control unit 122b of the play control interface 122b decides whether a scroll bar is moved from an event notified by the pointing device 123 (S2001). If the control unit 122b decides that the scroll bar is not moved (No at S2001), processing is completed.

On the other hand, if the control unit 122b decides that the scroll bar is moved (Yes at S2001), the control unit 122b obtains a start time and an end time represented by the moved scroll bar (s2002). If the start time is the earliest start time related to time figures and the end time is the latest end time related to time figures, the drawing unit 122a of the play control interface 122 draws the time figures (and a current position figure, a feature figure, a control figure, and a balloon figure) (S2003). The figure drawing processing is the same as FIGS. 14 and 16.

When a user sets play control such as a repeat play or a jump position on the play control screen 302, play control data is stored in the control data memory 122c.

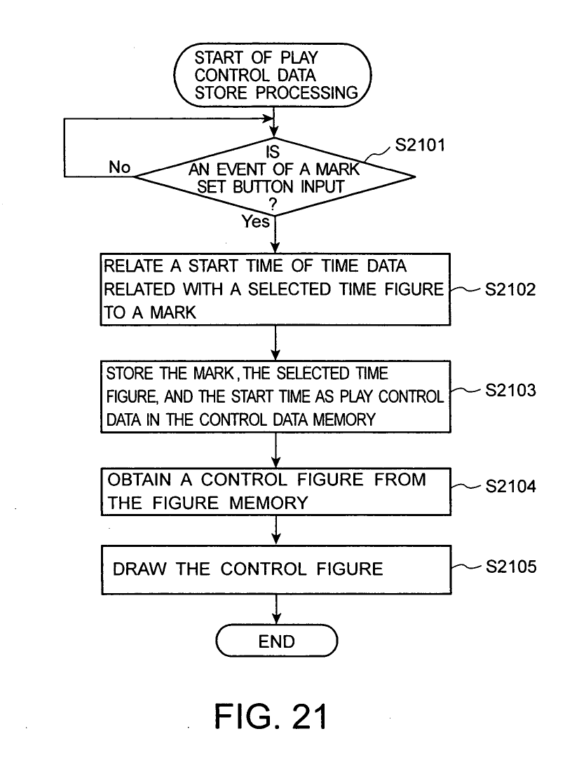

Next, store processing of play control data into the control data memory is explained. As an example of play control data, the case that a mark is set to a user's indicated time figure is explained. FIG. 21 is a flow chart of store processing of play control data into the control data memory.

One or a plurality of buttons are set on the pointing device 123, and an arbitrary button is assigned as a marking button. For example, in case of the pointing device as a mouse, a right side button of the mouse can be assigned as the marking button. In this case, a left side button of the mouse may be used an indication of play position. A user selects a time figure on the play control screen 302 by using the left side button of the pointing device 123, and pushes the marking button of the pointing device 123 in order to set a mark.

The control unit 122b of the play control interface 122 waits for an event of the marking button (S2101). When receiving the event of the marking button (Yes at S2101), the control unit 122b assigns a start time related with the selected time figure to the mark (S2102). The mark and the start time as play control data are stored in the control memory 122c as shown in FIG. 7 (S2103).

By referring to the mark in the play control data, the drawing unit 122a obtains a control figure corresponding to the mark from the figure memory 122d (S1204). In FIG. 7, a mark A12a corresponds to a control figure of repeat start position, and a mark A12b corresponds to a control figure of repeat end position.

The drawing unit 122a draws the control figure on the selected time figure of the play control screen 302 (S2105).

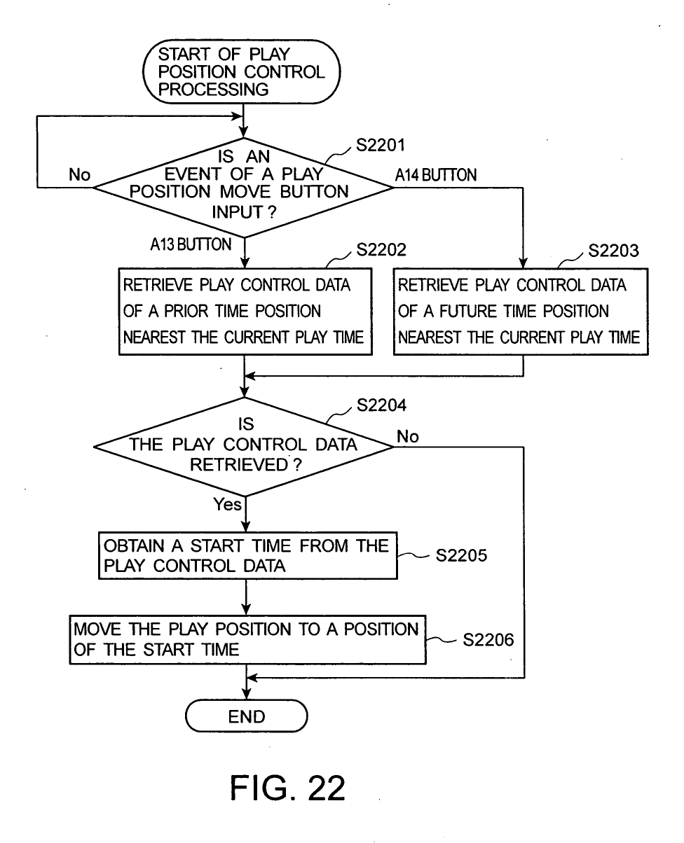

Next, in case that a user indicates a control figure displayed on the play control screen 302, play position control processing is explained. In FIG. 4, play position control processing in case of indicating buttons A13 and A14 is explained as an example. FIG. 22 is a flow chart of the play position control processing.

When a user pushes a play position move button of the pointing device 123, in response to an event of the play position move button, the control unit 122b decides whether button A13 is pushed or button A14 is pushed by the event (S2201).

If the control unit 122b decides that button A13 is pushed, the play control unit 121 retrieves play control data of a jump position mark of which start time is earlier than and nearest a current play time from the control data memory 122c (S2202)

On the other hand, if the control unit 122b decides that button A14 is pushed, the play control unit 121 retrieves play control data of a jump position mark of which start time is later than and nearest a current play time from the control data memory 122c (S2203).

The control unit 122b decides whether the play control data exists in the control data memory 122c (S2204). If the play control data does not exist (No at S2204), processing is completed.

On the other hand, if the play control data exists (Yes at S2204), the control unit 122b obtains a start time from the play control data (S2205), and moves a play position to a position of the start time (S2206). As a result, media data is played from the start position.

The play control data related with time data is not limited to example of FIG. 7. Feature data obtained from the feature data storage unit 130 may be play control data.

As mentioned-above, in the media data play apparatus 100, time figures each representing a different play time of media data are arranged (laid out) in time series on a rectangle area of the play control screen. By a user's indication of a desired time figure, a play position is moved to a position of the play time of the indicated time figure. Even if the play time of media data is long, a start time (start position) of each part of the media data is displayed with the same accuracy as indication accuracy of play position. Accordingly, a user can easily retrieve a play position of media data with high accuracy.

Furthermore, in the media data play apparatus of the first embodiment, a feature figure is also displayed on the play control screen. Accordingly, the user can understand contents of each part of media data without playing the media data.

Furthermore, in the media data play apparatus of the first embodiment, a control figure such as a repeat play or a jump play is also displayed on the play control screen. Accordingly, the user can easily understand a part of play control in the media data.

Furthermore, in the media data play apparatus of the first embodiment, a current play figure is displayed at a position of a time figure related with a current play time on the play control screen while playing media data. Accordingly, a user can easily understand a layout status of time figures each related with a different play time.

In the media data play apparatus 100 of the first embodiment, time figures each representing a play time of media data are arranged in time series on a rectangle area of the play control screen. However, in the second embodiment, time figures are arranged in time series along a horizontal direction. If an area of a horizontal width along one line is filled up with time figures, if a time figure changes from speech segment to non-speech segment, or if a time figure changes from a non-speech segment to a speech segment, the time figure is displayed by line feed.

In the second embodiment, components of the media data play apparatus 100 are the same as in the first embodiment of FIG. 1. Furthermore, hardware components of the media data play apparatus 100, and module components of a media data play program are the same as in the first embodiment.

In the media data play apparatus 100 of the second embodiment, a play control screen of the display apparatus 117 and figure drawing processing of the play control interface 122 are different from the first embodiment.

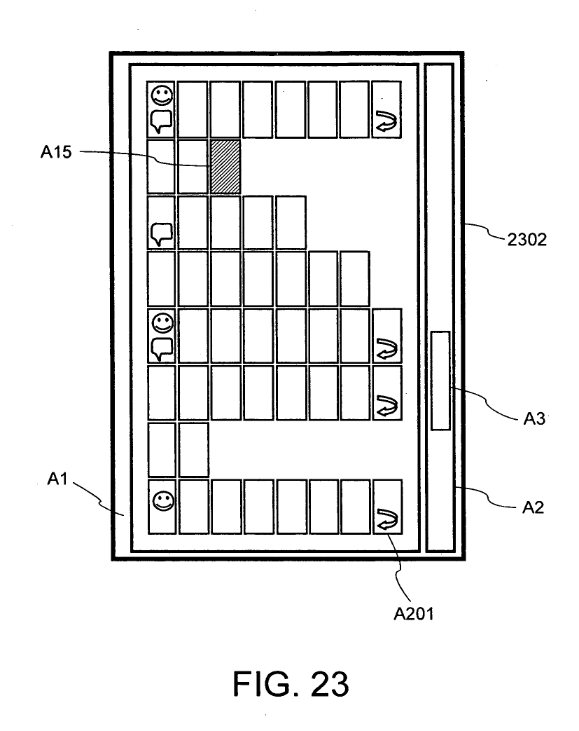

FIG. 23 is one example of the play control screen of the media data play apparatus according to the second embodiment. In FIG. 23, a dynamic image play area is omitted.

As shown in FIG. 23, in the play control screen 2302, time figures are arranged from the left side to the right side in earlier order of play time. If time figures are displayed by units of the number of columns displayable along the horizontal direction, a line feed figure A201 is displayed on a time figure of the last column position, and a next time figure is displayed from the left side along a next line.

Furthermore, in the play control screen 2302 of the second embodiment, in case of changing from a time figure of a non-speech segment to a time figure of a speech segment, or in case of changing from a time figure of a speech segment to a time figure of a non-speech segment, even if time figures are not displayed by units of the number of columns displayable along the horizontal direction, the next time figure is not displayed along this line, and a next time figure is displayed from the left side along a next line.

Furthermore, in the play control screen 2302 of the second embodiment, in case that change between speech segment and non-speech segment does not occur when time figures are displayed by units of the number of columns displayable along the horizontal direction, a line feed figure A201 is displayed on a time figure of the right side of this line in order for a user to understand that speech segment or non-speech segment continues to a next line.

Furthermore, in the play control screen 2302 of the second embodiment, the line and the column are replaced along layout direction of time figures. Accordingly, a scroll area A2 and a scroll bar A3 are set along a vertical direction.

In the play control screen 2302, a play button A4, a stop button A5, and a temporary stop button A6 are displayed. However, they are omitted in FIG. 23.

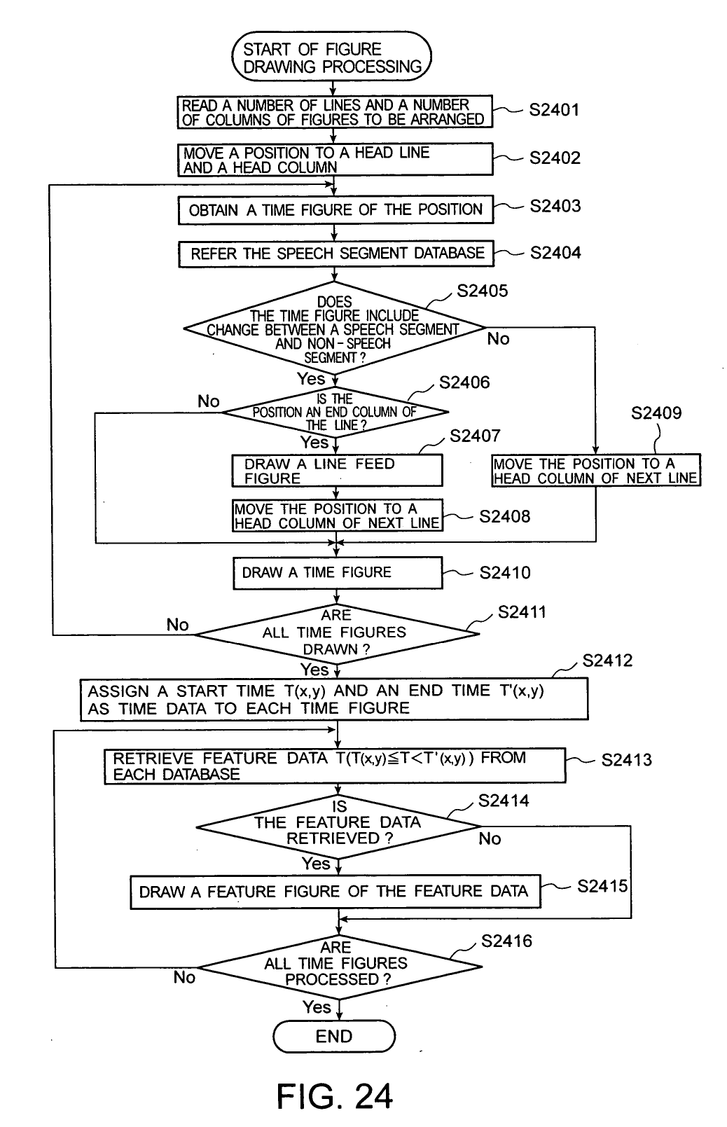

Next, figure drawing processing on the play control screen 2302 is explained. FIG. 24 is a flow chart of the figure drawing processing according to the second embodiment.

First, the drawing unit 122a of the play control interface 122 reads the number of lines and the number of columns of figures displayable in area A1 (S2401). In the same way as the first embodiment, the number of lines and the number of columns are previously stored in the control data memory 122c of the play control interface 122 based on a size of the play control screen 302.

Next, the drawing unit 122a moves a drawing position of figures to a head column of a head line (S2402), and obtains time figures related with play times to be drawn from the figure memory 122d (S2403).

Next, the control unit 122b obtains a start time and an end time of each time figure from the speech segment database 132, and checks whether the start time and the end time of a time figure and the start time and the end time of a previous time figure correspond to a speech segment or a non-speech segment (S2404). Briefly, the control unit 122b checks whether a speech segment of the time figure changes to a non-speech segment or whether a non-speech segment of the time figure changes to a speech segment (S2405).

If the control unit 122b decides that a change between speech segment and non-speech segment occurred (No at S2405), briefly, if speech segment changes to non-speech segment or the opposite case, the control unit 122b moves a drawing position to a head column of a next line (S2409), and draws a next time figure at the moved drawing position (S2410).

On the other hand, if the control unit 122b decides that a change between speech segment and non-speech segment did not occur (Yes at S2405), briefly, if speech segment or non-speech segment continues, the drawing unit 122a decides whether a current drawing position is the last column of the line (S2406).

If the drawing unit 122a decides that the current drawing position is the last column (Yes at S2406), the drawing unit 122a draws a line feed figure on a time figure of the last column (S2407), moves a drawing position to a head column of the next line (S2408), and draws the next time figure at the moved drawing position (S2410).

Processing from S2403 to S2410 is repeated until all time figures are drawn (S2411).

Hereinafter, assignment of time data (start time and end time) to time figures and drawing processing of feature figures (S2412-S2416) are executed in the same way as figure drawing processing (S1403-1407) of the first embodiment.

In this way, as shown in FIG. 23, in case of changing from speech segment to non-speech segment or the opposite case, the time figure is displayed by line feed.

The extraction processing of feature data from media data and play control processing of another media data are executed in the same way as the first embodiment.

As mentioned-above, in the media data play apparatus of the second embodiment, in case of changing from speech segment to non-speech segment or the opposite case, the time figure is displayed by line feed on the play control screen 2302. Briefly, a start position of speech segment or a start position of non-speech segment is always displayed on the left edge of the play control screen 2302. Accordingly, a user can easily search for the desired data as utterance unit from media data.

In the second embodiment, in case of changing from speech segment to non-speech segment or the opposite case, the time figure is displayed by line feed. However, in case of non-speech segment, time figures of the non-speech segment may not be displayed. In this case, when a user wants to play speech only in media data, time figures of non-speech segment unnecessary for the user are omitted. Accordingly, the user can easily search for the desired data as utterance unit from media data.

In the first and second embodiments, play control processing is executed in case of playing media data stored in the media data memory 111. In a third embodiment, play control processing is executed in case of obtaining media data being recorded in real time and playing the media data.

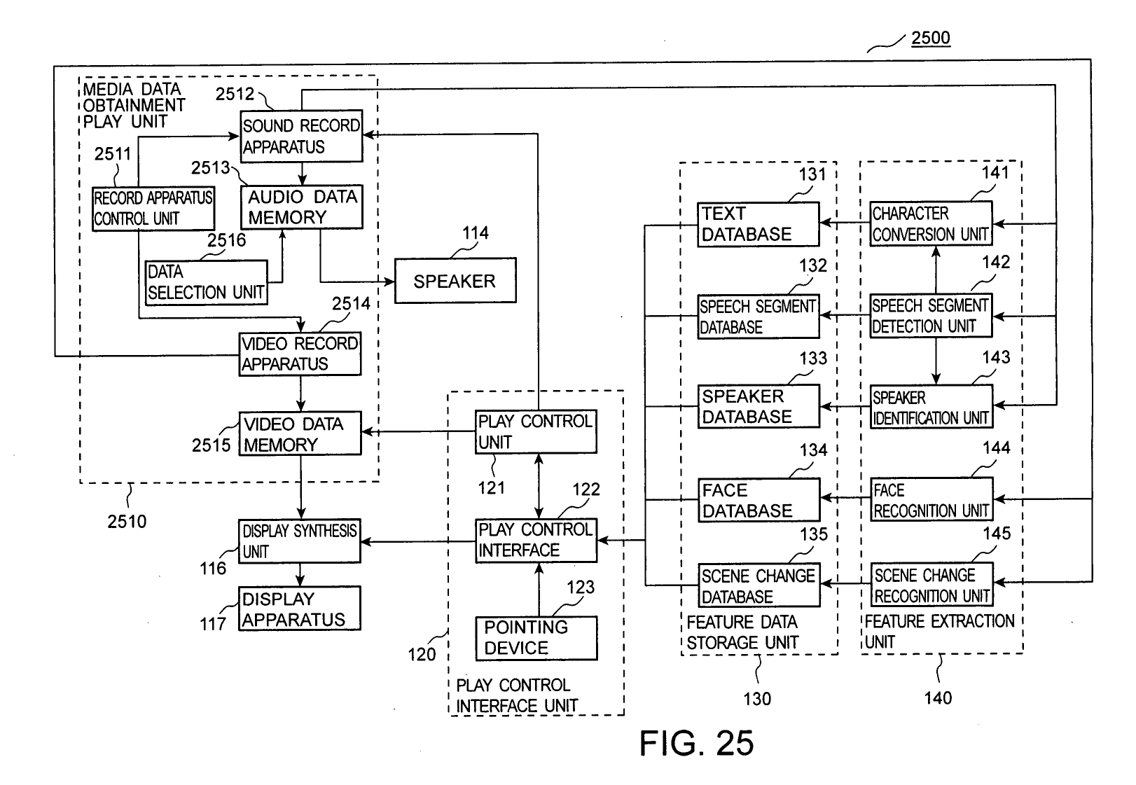

FIG. 25 is a block diagram of the media data play apparatus 2500 of the third embodiment. In FIG. 25, an arrow represents a data flow. As shown in FIG. 25, the media data play apparatus 2500 includes a media data obtainment play unit 2510, a play control interface unit 120, a feature data storage unit 130, and a feature extraction unit 140. The play control interface unit 120, the feature data storage unit 130 and the media data obtainment unit 140 are the same as in the first embodiment.

The media data obtainment unit 2510 records/plays media data, and includes a record apparatus control unit 2511, a sound record apparatus 2512, an audio memory 2513, a video record apparatus 2514, a video data memory 2515, and a data selection unit 2516. The media data obtainment unit 2510 connects with a speaker 114 and a display apparatus 117 through a display synthesis unit 116.

The data selection unit 112, the speaker 114, the display synthesis unit 116 and the display apparatus 117 are the same as each unit of the media data play unit 110 of the first embodiment.

The sound record apparatus 2512 (such as a microphone or a radio broadcast receiving apparatus) obtains video data. The video record apparatus 2514 (such as a video camera) obtains video data. As an apparatus using the video record apparatus 2514 and the sound record apparatus 2512, for example, a video camera or a television broadcast receiving apparatus is applied.

The record apparatus control unit 2511 controls the video record apparatus 2514 and the sound record apparatus 2512. A user executes record operation through the record apparatus control unit 2511.

The audio data memory 2513 stores audio data obtained by the sound record apparatus 2512. The video data memory 2515 stores video data obtained by the video record apparatus 2514.

In the third embodiment, a hardware component of media data play apparatus and a module component of media data play program are the same as in the first embodiment.

An obtainment resource of time series media data may be, as for speech, a microphone, a radio broadcast, or a speech streaming delivery through a network such as an Internet. As for dynamic image, the obtainment resource may be a video camera, a television broadcast, or a dynamic streaming delivery through a network such as an Internet.

When a user indicates record by the record apparatus control unit 2511, the video record apparatus 2514 begins to send video data to the video data memory 2515 and the feature extraction unit 140. The sound record apparatus 2512 begins to send audio data to the audio data memory 2513 and the feature extraction unit 140.

The feature extraction unit 140 executes feature data extraction processing in the same way as in the first embodiment. The video data memory 2515 and the audio data memory 2513 store respective data.

In the same way as in the first embodiment, a user operates play control using the play control interface 122. In case of starting play, the video data memory 2515 begins to send the video data to the display synthesis unit 116, and the audio data memory 2513 begins to send the audio data to the speaker 114.

The extraction processing of feature data from media data and play control processing of media data are executed in the same way as in the first embodiment.

In the third embodiment, the media data play apparatus includes the sound record apparatus 2512 and the video record apparatus 2514. However, by setting the sound record apparatus 2512 and the video record apparatus 2514 outside the media data apparatus and by connecting the media data apparatus with the sound record apparatus 2512 and the video record apparatus 2514, video and sound may be obtained in real time.

Furthermore, in the third embodiment, feature data is extracted in real time from media data being recorded, and a time figure and a feature figure are displayed on the play control screen. However, in case of streaming-delivering media data from a media data delivery apparatus connected to a network such as the Internet, by receiving media data delivered in order and by extracting feature data from the received media data, a time figure and a feature figure may be displayed on the play control screen.

Furthermore, in case of storing feature data as meta data in the media data delivery apparatus and of streaming-delivering the meta data, by receiving the meta data streaming-delivered, feature data may be obtained. In this case, the feature extraction unit and the feature data storage unit are unnecessary.

Furthermore, the time figure and the control figure may be displayed on the play control screen without the feature figure. In this case, the feature extraction unit and the feature data storage unit are unnecessary.

In this way, in the third embodiment, in case that a user wants to confirm contents of media data being recorded, feature data of the media data are obtained in real time using the play control screen. Accordingly, the user can easily confirm the contents by actually playing the media data.

In the media data play apparatus of the first, second, and third embodiments, a time figure, a current position figure, a control figure, and a feature figure are displayed on the play control screen. However, in a fourth embodiment, the time figure and the current position figure are only displayed on the play control screen.

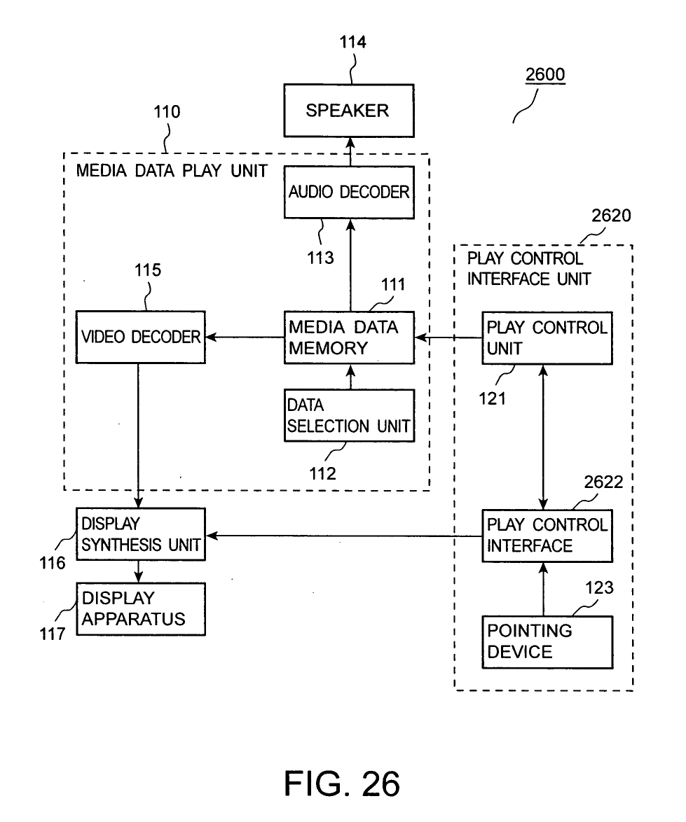

FIG. 26 is a block diagram of the media data play apparatus according to the fourth embodiment. In FIG. 26, arrows represent data flow. As shown in FIG. 26, the media data play apparatus includes a media data play unit 110 and a play control interface unit 2620. The media data play unit 110 is the same as that of the first embodiment. Furthermore, hardware component of the media data play apparatus of the fourth embodiment is the same as that of the first embodiment.

In the play control interface unit 2620 of the fourth embodiment, the drawing unit 122a displays a time figure and a current position figure on the play control screen, and does not display a feature figure. Accordingly, in the media data play apparatus 2600, the feature extraction unit and the feature data storage unit are not included.

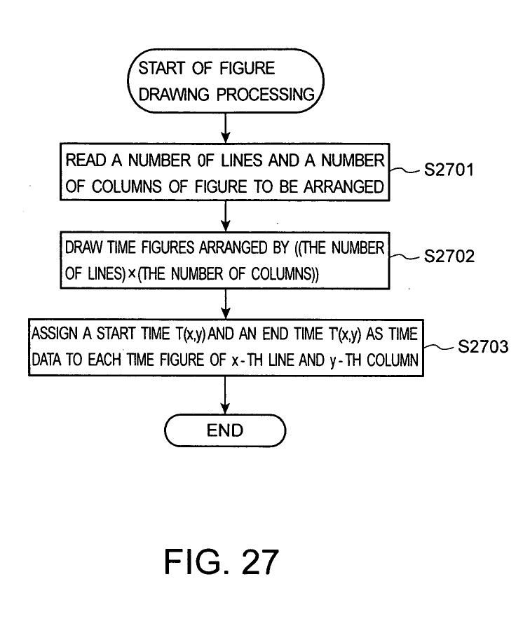

Next, figure drawing processing on the play control screen in the media data play apparatus 2600 is explained. FIG. 27 is a flow chart of the figure drawing processing of the fourth embodiment.

First, the drawing unit 122a of the play control interface 2622 reads the number of lines and the number of columns of figures displayable in area A1 of the play control screen 302 shown in FIG. 4 (S2701). In the same way as the first embodiment, the number of lines and the number of columns are previously stored in the control data memory 122c of the play control interface 122 based on a size of the play control screen 302.

Next, the drawing unit 122a draws time figures each representing a play time on the area A1 (S2702). The number of time figures is “(the number of lines)×(the number of columns)”. The control unit 122b assigns a start time and an end time to each time figure. An identifier of the time figure, the start time, and the end time are stored as time data (FIG. 6) in the control data memory 122c (S2703).

In this way, the time figure is displayed on the play control screen. Drawing of the current position figure is executed in the same way as the first embodiment. Furthermore, in the fourth embodiment, in addition to the time figure and the current position figure, the control figure may be also displayed.

As mentioned-above, in the fourth embodiment, the feature figure is not displayed. Briefly, extraction of feature of media data is unnecessary, and the feature extraction unit and the feature data storage unit are unnecessary. Accordingly, component of the apparatus or the program becomes simple. Furthermore, processing speed of play control rises. For example, in case that a feature extraction unit or a feature extraction program can not be included into a music play apparatus of portable type, the fourth embodiment is applied.

In the media data play apparatus of the first, second and third embodiments, feature data is extracted from media data, and a feature figure is displayed based on the feature data. However, in a fifth embodiment, play of media data including meta data ad feature data is controlled.

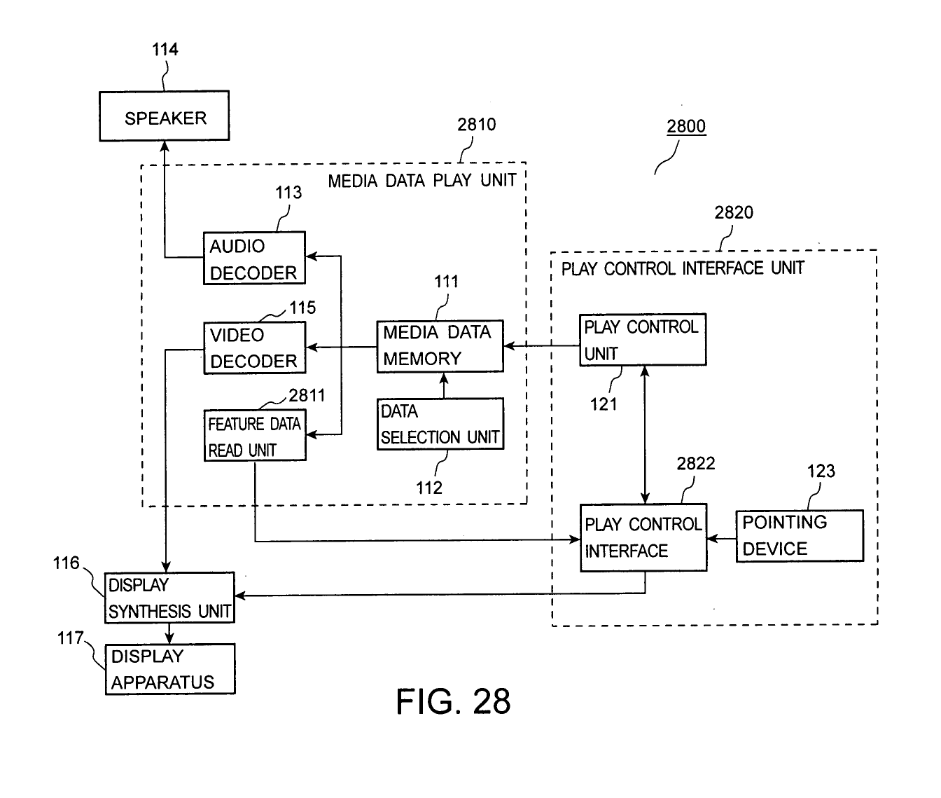

FIG. 28 is a block diagram of the media data play apparatus according to the fifth embodiment. In FIG. 28, arrows represent data flow. As shown in FIG. 28, the media data play apparatus includes a media data play unit 2810 and a play control interface unit 2820.

In the media data play apparatus 2800 of the fifth embodiment, feature data (text data, speech segment data, speaker data, face data, scene change data) are recorded as meta data in media data.

In the media data play unit 2810, a feature data read unit 2811 to obtain text data, speech segment data, speaker data, face data, and scene change data by referring to meta data stored in the media data memory 111 is set. Other components of the media data play unit 2810 are the same as in the first embodiment.

Furthermore, in the play control interface 2820, the drawing unit 122a of the play control interface 2822 obtains feature data from the feature data read unit 2811 in case of drawing a feature figure on the play control interface screen 302. Other components of the play control interface 2820 are the same as in the first embodiment.

Accordingly, in the media data play apparatus 2800 of the fifth embodiment, different from the first embodiment, the feature extraction unit and the feature data storage unit are not set.

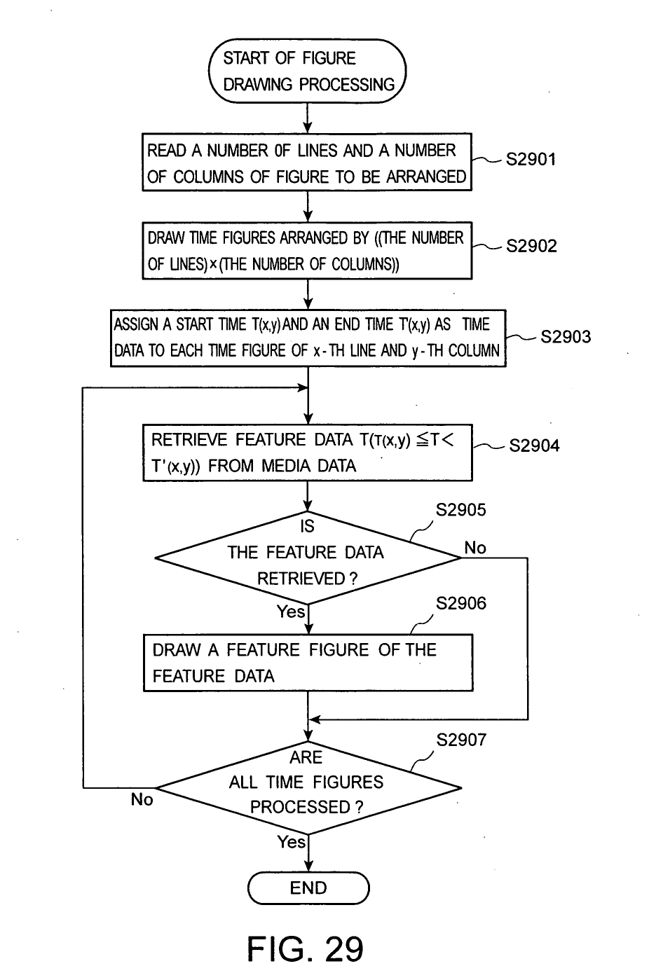

FIG. 29 is a flow chart of figure drawing processing on the play control screen by the media data play apparatus 2800 of the fifth embodiment. In the fifth embodiment, at S2904, retrieval of feature data T(T(x,y)≦T≦T′(x,y)) by the feature data read unit 2811 is different from figure drawing processing of the first embodiment. Other processing of the fifth embodiment is the same as figure drawing processing of FIG. 14. Furthermore, play control processing of the fifth embodiment is the same as the first embodiment.

In this way, in the media data play apparatus 2800 of the fifth embodiment, a feature figure is displayed using feature data recorded as meta data in the media data memory 111. Accordingly, the feature extraction unit and the feature data storage unit are unnecessary, and apparatus component is simple. Furthermore, speed of play control processing rises because feature extraction processing is unnecessary.

The play control interface 2822 may obtain necessary feature data through the feature data read unit 2811 if necessary. For example, at a time when a user changes a feature figure from non-display status to display status during playing media data, the feature data read unit 2811 may obtain feature data first.

Furthermore, in the media data play apparatus of the first, second, third, fourth, and fifth embodiments, the play control screen is displayed on the display apparatus including the dynamic image screen. However, the play control screen may be displayed by another display apparatus.

In the media data play apparatus of the first, second, third, fourth, and fifth embodiments, display of the play control screen, user's indication of play control from the screen, feature data extraction processing, and play control processing based on the user's indication and media data play processing are executed in the same apparatus. However, in a sixth embodiment, an apparatus for displaying the play control screen and indicating a user's play control from the screen is different from an apparatus for executing the feature data extraction processing, play control processing based on the user's indication, and media data play processing.

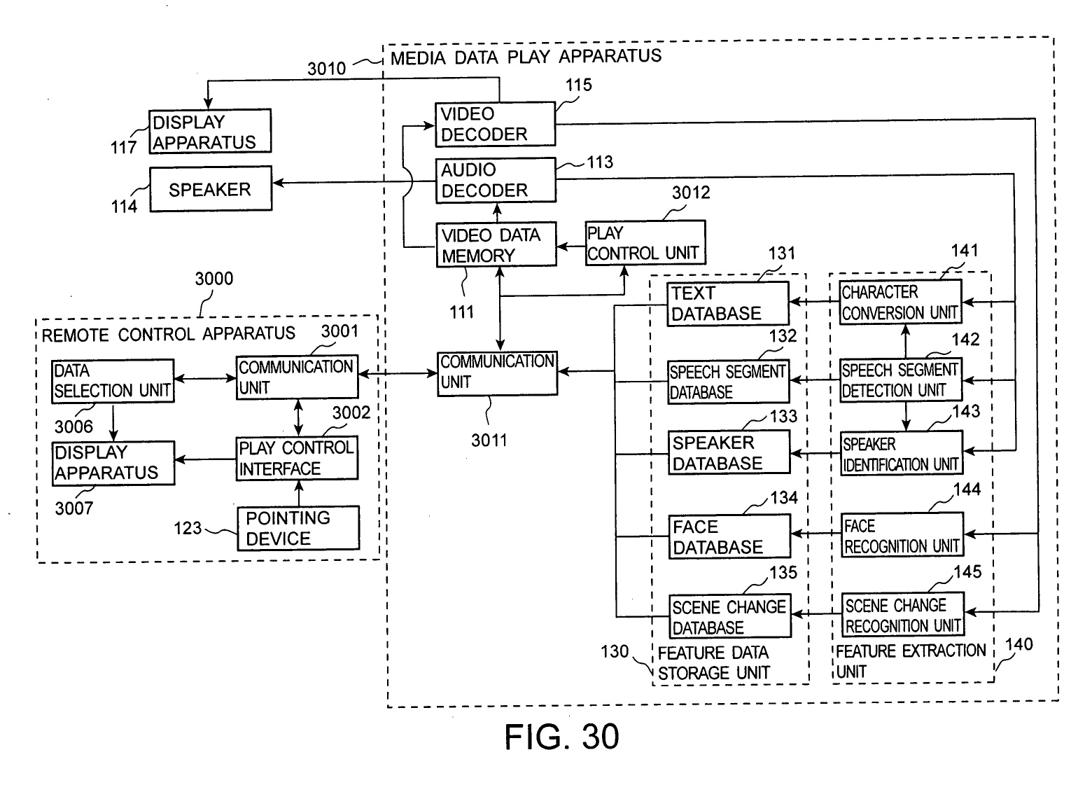

FIG. 30 is a block diagram of a media data play system according to the sixth embodiment. In FIG. 30, arrows represent data flow.

In the media data play system, a remote control apparatus 3000 and a media data play apparatus 3010 communicate through a wireless communication network.

The remote control apparatus 3000 displays a play control screen and indicates a play control from the screen to the media data play apparatus 3010. As shown in FIG. 30, the remote control apparatus 3000 includes a communication unit 3001, a play control interface 3002, a data selection unit 3006, a pointing device 123, and a display apparatus 3007.

The communication unit 3001 controls communication with the media data play apparatus 3010.

The play control interface 3002 displays various figures of play control (time figure, feature figure, control figure) for a user on the display apparatus 3007. Furthermore, the play control interface 3002 receives an event of time figure indicated by the pointing device 123 from the user, and requests the media data play apparatus 3010 to move a media data play position to a play time position of indicated time figure and another play control processing through a network. Components of the play control interface 3002 are the same as play control processing of the first embodiment in FIG. 1.

The data selection unit 3006 requests a retrieval of media data recorded in the media data memory 111 of the media data play apparatus 3010 through the network, and selects media data to be played.

The pointing device 123 is a generic input apparatus such as a touch panel of a remote controller, a command navigation of a cellular-phone, or a mouse.

The display apparatus 3007 is, for example, a liquid screen of a remote controller and a cellular-phone.

The media data play apparatus 3010 executes the feature data extraction processing, play control processing based on a user's indication, and media data play processing. As shown in FIG. 30, the media data play apparatus 3010 includes a video decoder 115, an audio decoder 113, a media data memory 111, a play control unit 3012, a communication unit 3011, a feature data storage unit 130, and a feature extraction unit 140. A display apparatus 117 and a speaker 114 are connected with the media data play apparatus 3010.

The video decoder 115, the audio decoder 113, the display apparatus 117, the speaker 114, the media data memory 111, the feature data storage unit 130, and the feature extraction unit 140 are the same as in the media data play apparatus of the first embodiment.

The communication unit 3011 controls communication with the remote control apparatus 3000. The play control unit 3012 controls play of media data from a play position indicated by a request from the play control interface 3002 of the remote control apparatus 3000 through the network.

The feature data storage unit 130 is, for example, a memory medium such as a HDD, to store feature data extracted by the feature extraction unit 140. The component is the same as in the feature data storage unit 130 of the first embodiment.

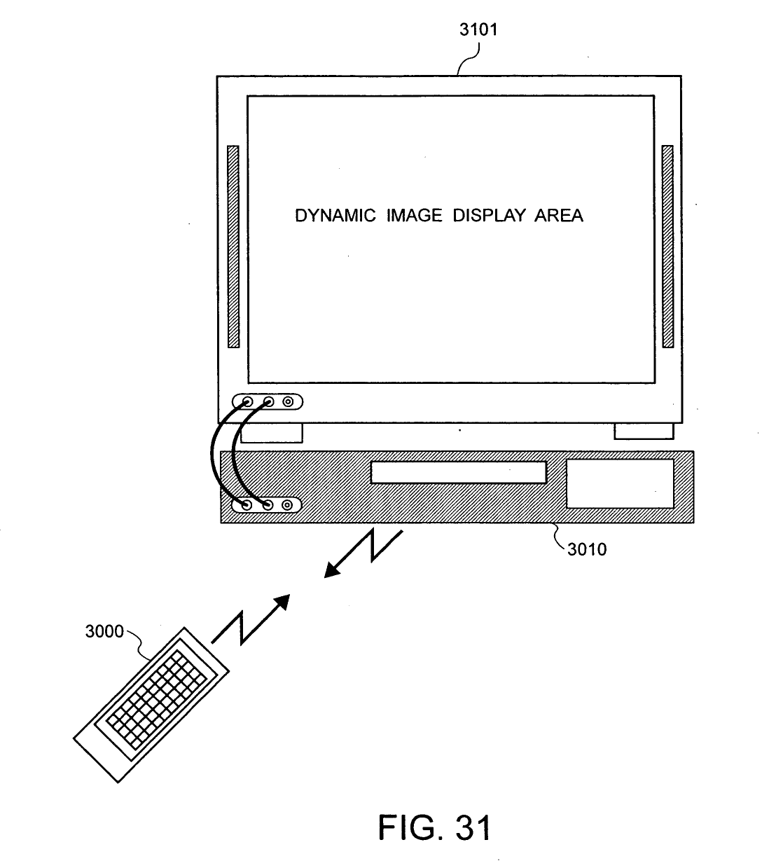

Next, hardware components of the remote control apparatus 3000 and the media data play apparatus 3010 are explained. FIG. 31 is a schematic diagram of hardware components of the remote control apparatus 3000 and the media data play apparatus 3010. The media data play apparatus 3010 is a video play apparatus or a DVD player to output video and sound to a television 3101. The remote control apparatus 3000 remotely operates play control of the video play apparatus or the DVD player.

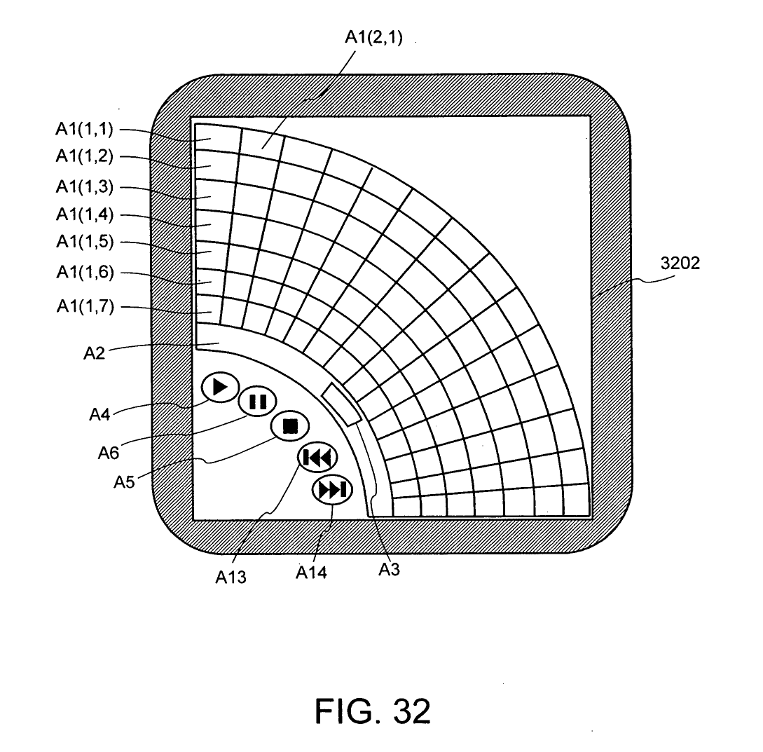

FIG. 32 is a schematic diagram of one example of the play control screen 3202, as a LCD of a remote controller (remote control apparatus 3000) including an infrared ray communication function.

As shown in FIG. 32, time figures A1(1,1) A1(1,2), . . . , A1(1,7), A1(2,1), . . . , are arranged (laid out) as a two-dimensional circular arc on the play control screen 3202. Furthermore, a feature figure, a control figure, and a current position figure are overlap-displayed on the time figure. The number of time figures and the layout shape are not limited to the example of FIG. 32.

Furthermore, in the play control screen 3202, a scroll bar A3 is movably displayed in a scroll area A2. A function of the scroll bar is the same as in the first embodiment.

In addition to a remote controller used as the remote control apparatus 3000, a cellular-phone including Bluetooth function may be used as the remote control apparatus 3000. In this case, the communication units 3001 and 3011 correspond to Bluetooth function.

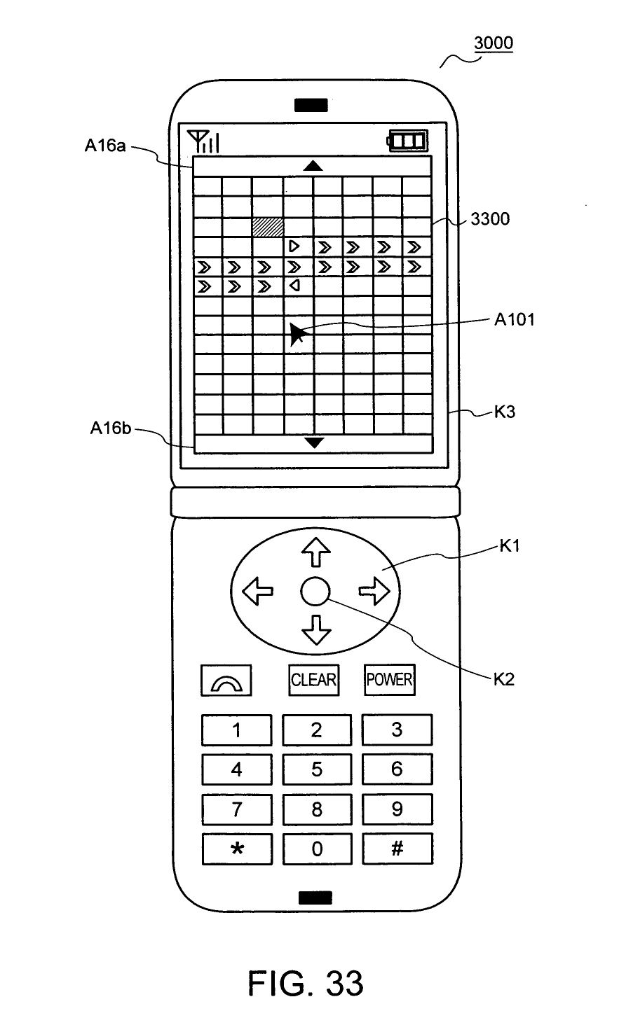

FIG. 33 is schematic diagram of one example of the play control screen 3300 in case of using the cellular-phone as the remote control apparatus 3000. As shown in FIG. 33, the play control screen 3300 is displayed on a screen of the cellular-phone. A cursor A101 is displayed on the play control screen 3300. By operating the cursor A101 using a cross key K1 (corresponding to the pointing device 123) of a command navigation button of the cellular-phone and pushing a select key K2, the play control interface 3002 moves a play position to a position of play time related to time figure indicated by the cursor A101.

Scroll buttons A16a and A16b include the same function as the scroll area A2 and the scroll bar A3 in FIG. 1. They are used to scroll a display area of time figures.

For example, in case of pushing the scroll bar A16a, time figures related with past play time compared with the current play time are displayed. In case of pushing the scroll bar A16b, time figures related with future play time compared with the current play time are displayed. In this way, the display area of time figures can be scrolled.

The user operates the data selection unit 3006 of the remote control apparatus 3000, and selects by retrieving media data in the media data memory 111 through the communication units 3001 and 3011.

In the sixth embodiment, each media data is related with a name (or number) uniquely specified in the media data memory 111. By displaying the name on the display apparatus 3007 of the remote control apparatus 3000 or the display apparatus 117 connected with the media data play apparatus 3010, a user can select the media data.

In case of completing selection operation of media data, in the same way as in the first embodiment, feature data of media data is extracted by the feature extraction unit 140 and stored in the feature data storage unit 130. Even if selection operation of media data is completed, feature extraction processing may be immediately executed and stored in each database. Briefly, extracted feature data may be stored in each database in response to a user's operation.

Furthermore, in case of extracting feature data of media data once, each feature data is already stored in the feature data storage unit 130. Accordingly, if the same media data is selected again, processing of the feature extraction unit 140 is unnecessary.

Next, in the media data play system of the sixth embodiment, play control processing of media data is explained. When a user pushes a play button A4 using the pointing device 123 and the play control screen 3202 of the remote control apparatus 3000, an event of the play button A4 is sent to the play control unit 3012 of the media data play apparatus 3010 through the communication units 3001 and 3011. In response to the event, the play control unit 3012 sends a play instruction to the media data memory 111, and media data is sent from the media data memory 111 to at least one of the audio decoder 113 and the video decoder 115. The audio decoder 113 and the video decoder 115 process the received media data. The video decoder 115 sends video data to the display apparatus 117, and the audio decoder 113 sends audio data to the speaker 114.

The play control interface 3002 of the remote control apparatus 3000 receives feature data from the feature data storage unit 130 through the communication units 3011 and 3001, and displays a feature figure corresponding to the received feature data on the display apparatus 3007.

When a user selects a time figure, a feature figure or a control figure with the pointing device 123, a time related with the selected figure is sent to the play control unit 3012 through the communication units 3001 and 3011. The play control unit 3012 sends the media data memory 111 an instruction to send media data of the time to the video decoder 115 and the audio decoder 113.

Next, data communicated between the remote control apparatus 3000 and the media data play apparatus 3010 is explained.

The data includes the following three types. The first type is data necessary for the data selection unit 3006 of the remote control apparatus 3000. The second type is data necessary for display of the play control screen 3202. The third type is play control data.

The data necessary for the data selection unit 3006 is a name (identifier) and a length of the media data. In order for the data selection unit 3006 of the remote control apparatus 3000 to select the media data, the name and the length of the media data are sent from the media data play apparatus 3010 to the remote control apparatus 3000.

When a user selects media data by the data selection unit 3006, information of selected media data is sent from the remote control apparatus 3000 to the media data play apparatus 3010, and is sent to the media data memory 111.

The second type is data sent/received for display of the play control screen 3202. The play control interface 3002 of the remote control apparatus 3000 needs length (time) data of media data selected by the data selection unit 3006 in order to display time figures, the scroll area A2, and the scroll bar A3 in FIG. 32. Accordingly, after selecting media data by the data selection unit 3006, the media data play apparatus 3010 sends length data of the media data to the remote control apparatus 3000, and the remote control apparatus 3000 receives the length data. Furthermore, in order to determine a display position of a current position figure on the play control screen 3202, the remote control apparatus 3000 receives current play time data (a current play position) from the media data play apparatus 3010.

In case of displaying the time figure and the current position figure without the feature figure on the play control screen 3202, only length data of the media data and current play time data are obtained from the media data play apparatus 3010.

In addition to the time figure and the current position figure, in case of displaying the feature figure on the play control screen 3202, the remote control apparatus 3000 further obtains each feature data of media data stored in the feature data storage unit 130 of the media play apparatus 3010.

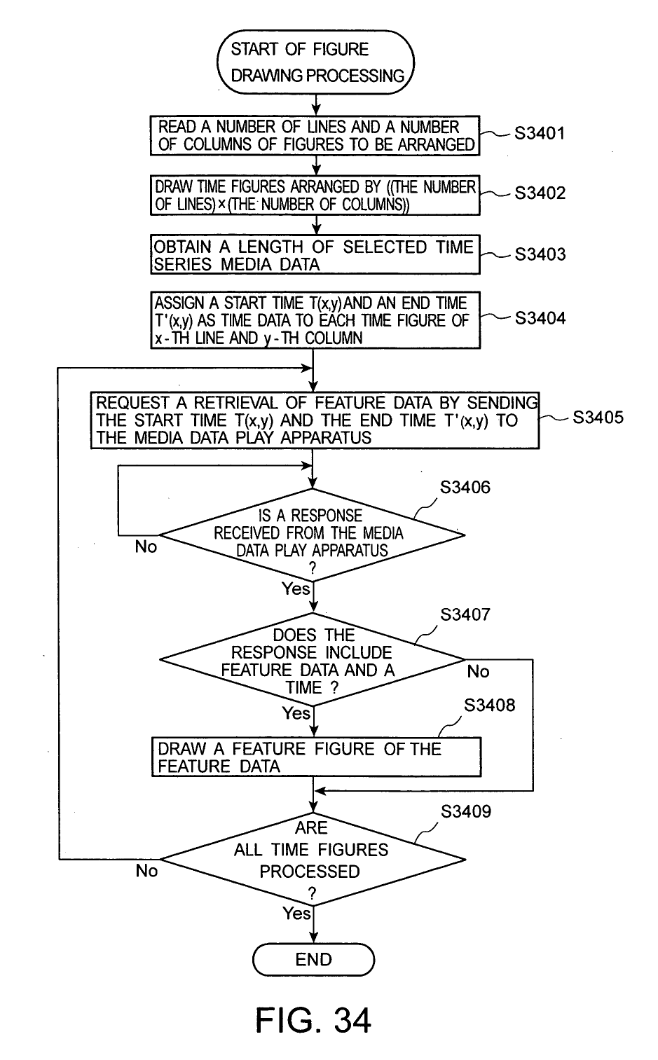

Figure drawing processing on the play control screen 3202 is explained. FIG. 34 is a flow chart of the figure drawing processing in the remote control apparatus 3000.

First, the drawing unit 122a of the play control interface 3002 reads a number of lines and a number of columns of figures displayable in area A1 (S3401). The number of lines and the number of columns are previously stored in the control data memory 122c of the play control interface 3002 based on a size of the play control screen 3202.

Next, the drawing unit 3002 draws time figures, each related to a different play time in time series order on the area A1 (S3402). The number of time figures is equal to “(the number of lines)×(the number of columns)”. In FIG. 32, the time figures are displayed as A1(1,1), A1(1,2), . . . , A1(1,7), A1(2,1), . . . .

Next, the drawing unit 122a inquires of the media data play apparatus 3010 through the communication unit 3001 about length data of media data selected by the data selection unit 3006. In response to an inquiry, the remote control unit 3000 sends length data of the selected media data, and the play control interface 3002 obtains the length data (S3403).

The control unit 122b of the play control interface 3002 assigns a start time and an end time to each time figure, and stores the time figure, the start time, and the end time as time data in the control data memory 122c (S3404). This assignment processing is the same as in the first embodiment.

The following processing is executed for all time figures displayed on the play control screen 3202. However, in order to simplify the explanation, only a time figure located at the x-th line and the y-th column is explained.

As a retrieval request of feature data, the drawing unit 122a sends the start time T(x,y) and the end time T′(x,y) assigned to the time figure of x-th line and y-th column to the media data play apparatus 3010 through the communication unit 3001 (S3405). In the media data play apparatus 3010, feature data related with T(T(x,y)≦T≦T′(x,y)) is retrieved from the feature data storage unit 130. The drawing unit 122a of the remote control apparatus 3000 waits for a response of feature data retrieval result from the media data play apparatus 3010 (S3406). The feature data retrieval processing of the media data play apparatus is explained afterward.

In case of receiving a response from the media data play apparatus 3010, the drawing unit 122a checks whether the response includes feature data and a time (related with the feature data) (S3407). If the response includes the feature data and the time (Yes at S3407), the drawing unit 122a retrieves a feature figure corresponding to the feature data from the figure memory 122d, and displays the feature figure on a time figure related with the time (S3408). On the other hand, if the response does not include the feature data and time (No at S3407), the drawing unit 122a decides that the feature data cannot be retrieved, and does not draw a feature figure on the time figure.

Processing from S3405 to S3408 is executed for all time figures (S3409). In this way, the time figure and the feature figure are displayed on the area A1.

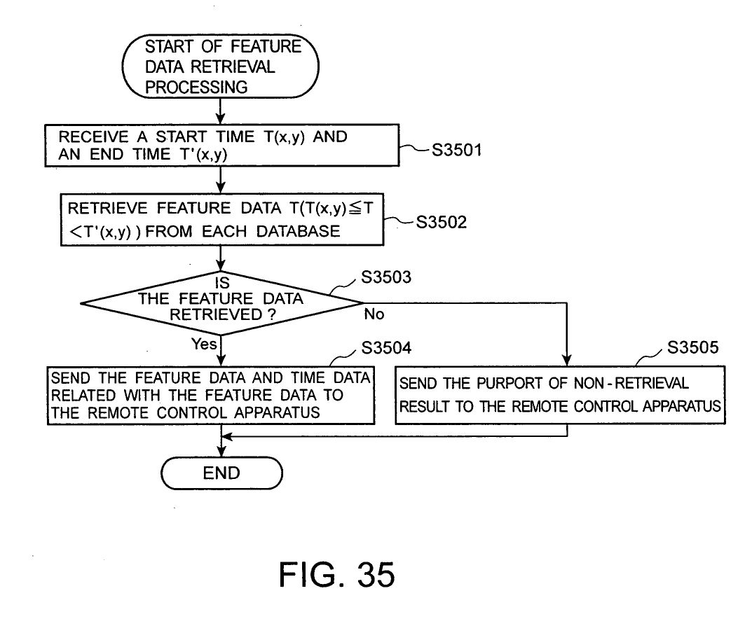

Next, in the media data play apparatus 3010 receiving a retrieval request of feature data at S3405, feature data retrieval processing is explained. FIG. 35 is a flow chart of the feature data retrieval processing.

In the media data play apparatus 3010, in case of receiving a retrieval request (a start time T(x,y) and an end time T′(x,y) assigned with the time figure of x-th line and y-th column) of feature data through the communication unit 3011 (S3501), feature data (speech segment data, speaker data, text data, face segment data, or scene change data) related with time T(T(x,y)≦T≦T′(x,y)) is respectively retrieved from the feature data storage unit 130 (the speech segment database 132, the speaker database 133, the text database 131, the face database 134, or the scene change database 135) (S3502).

The feature data storage unit 130 decides whether the feature data exists (S3503). In case of deciding that the feature data exists (Yes at S3503), the feature data storage unit 130 sends the feature data and the time (related with the feature data) to the remote control apparatus 3000 through the communication unit 3011 (S3504).

On the other hand, in case of deciding that the feature data does not exist (No at S3503), the feature data storage unit 130 sends a response as non-retrieval result to the remote control apparatus 3000 through the communication unit 3011 (S3505).

Response at S3504 or S3505 of FIG. 35 is received at S3406 of FIG. 34 in the figure drawing processing of the remote control apparatus.

Next, play control data as the third type of data sent/received between the remote control apparatus 3000 and the media data play apparatus 3010 is explained.

In case of generating operation of play control of media data (play start, play stop, move of play position) based on a user's operation of the pointing device 123 on the play control screen 3202, the remote control apparatus 3000 sends an operation instruction as play control data to the play control unit 3012 of the media data play apparatus 3010. The play control unit 3012 executes processing of the operation instruction using the play control data.

When a user indicates a time figure of his/her desired play position on the play control screen of the remote control apparatus 3000, the control unit 122b of the play control interface 3002 obtains a play time of the indicated time figure from the control data memory 122c, and sends the play time as play control indication data to the media data play apparatus 3010 through the communication unit 3001. In the media data play apparatus 3010, the communication unit 3011 receives a play time as the play control indication data, and the play control unit 3012 plays media data from a position of the play time.

As mentioned-above, in the media data play system of the sixth embodiment, the remote control apparatus 3000 displays time figures on the play control screen, and sends a play control indication that a play position is moved to a position of play time of a time figure (selected by a user from the time figures) to the media data play apparatus 3010. In the media data play apparatus 3010, media data is played from a position of play time indicated by the play control indication (received from the remote control apparatus 3000). Even if the user locates a place distant from the media data play apparatus 3010, time data of each part of media data of which total play time is long is displayed with the same accuracy as indication accuracy of play position. Accordingly, the user can easily retrieve a desired play position of media data with high accuracy.

Furthermore, in the media data play system of the sixth embodiment, the play control screen is displayed in the remote control apparatus 3000. Accordingly, the display apparatus 117 of the media data play apparatus 3010 can be used for play display of media data only.

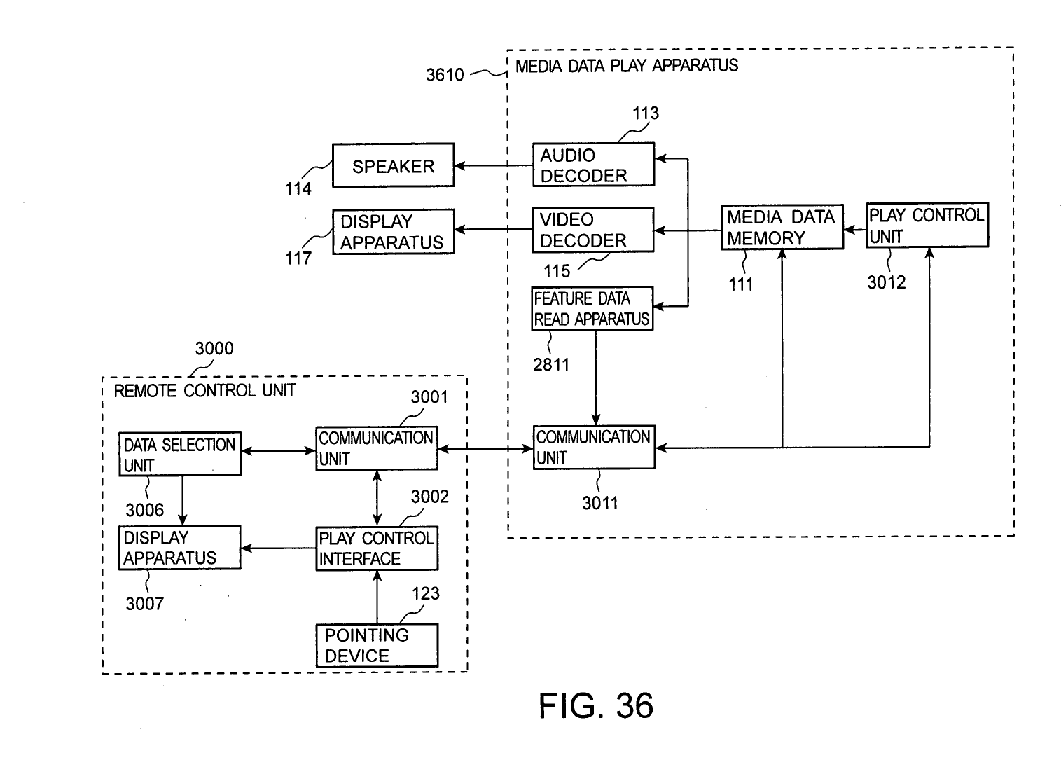

In the sixth embodiment, the media data play apparatus 3010 includes the feature extraction unit 140 and the feature data storage unit 130 in the same way as in the first embodiment. However, in the same way as in the fourth embodiment where only time figure and control figure are displayed on the play control screen 3202 or in the fifth embodiment where media data including meta data (feature data) recorded in the media data record unit is played, the feature extraction unit 140 and the feature data storage unit 130 may not be included. FIG. 36 is a block diagram of the media data play system not including the feature extraction unit 140 and the feature data storage unit 130.

Furthermore, on the play control screen 3202 of the remote control apparatus 3000, time figures may be displayed in the same way as in the second embodiment. For example, each time figure may be displayed in time order along the horizontal direction on the play control screen. In case of fully displaying time figures in area of horizontal width along one line, in case of changing from speech segment to non-speech segment, or in case of changing from non-speech segment to speech segment, the next time figure is displayed at a head position along the next line by line feed.

Furthermore, in the media data play apparatus 3010, in the same way as in the third embodiment, play control may be executed while playing media data recoded in real time.

In the disclosed embodiments, the processing can be accomplished by a computer-executable program, and this program can be realized in a computer-readable memory device.

In the embodiments, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. An apparatus for playing media data, comprising:
a media data memory configured to store media data playable in time series, the media data including at least one of speech data and image data;
a play control display unit configured to display a plurality of time figures, each time figure corresponding to a play time of a part of the media data in time series order;
a data selection unit configured to select at least one time figure from the plurality of time figures through said play control display unit;
a play control unit configured to move a play position to a part of the play time corresponding to the at least one time figure in the media data; and
a play unit configured to play the media data from the play position moved by said play control unit.

2. The apparatus according to claim 1,
further comprising a control data memory configured to store time data of each time figure, the time data including an identifier of the time figure, a start time and an end time of a play time corresponding to the time figure in the media data.

3. The apparatus according to claim 2,
wherein said play control display unit two-dimensionally displays the plurality of time figures in time series order on a screen.

4. The apparatus according to claim 3,
wherein said play control display unit displays a current position figure representing a current play position of the media data in relation to a time figure of the current play position.

5. The apparatus according to claim 4,
wherein said data selection unit indicates a play control to at least two time figures,
wherein said control data memory stores play control data including a mark of a control figure and identifiers of the at least two time figures, and
wherein said play control display unit respectively displays the control figure in relation to the at least two time figures.

6. The apparatus according to claim 1,
wherein said play control display unit includes a scroll unit configured to movably indicate an area of the media data, and displays the plurality of time figures corresponding to the area of the media data, each time figure corresponding to a position of play time of each part of the area in time series order.

7. The apparatus according to claim 1,
further comprising:
a feature extraction unit configured to extract feature data from a part of the media data; and
a feature data storage unit configured to store the feature data and a play time of the part of the media data;
wherein said play control display unit displays a feature figure representing the feature data in relation to a time figure of the play time.

8. The apparatus according to claim 7,
wherein said feature extraction unit detects a speech segment as a start time and an end time of a part including speech from the media data,
wherein said feature data storage unit stores the speech segment as the start time and the end time, and
wherein said play control display unit displays the feature figure representing speech in relation to a time figure of a play time including the speech segment.

9. The apparatus according to claim 8,
wherein said play control display unit discriminately displays a time figure of a play time including the speech segment and a time figure of a play time not including the speech segment.

10. The apparatus according to claim 8,
wherein said play control unit displays only the plurality of time figures each play time including the speech segment.

11. The apparatus according to claim 8,
wherein said feature extraction unit identifies a speaker from speech data of the speech segment,
wherein said feature data storage unit stores an identifier of the speaker and the speech segment, and
wherein said play control display unit displays the feature figure representing the identifier in relation to a time figure of a play time including the speech segment.

12. The apparatus according to claim 8,
wherein said feature extraction unit converts speech data of the speech segment to text data,
wherein said feature data storage unit stores the text data and the speech segment, and
wherein said play control display unit displays the feature figure representing the text data in relation to a time figure of a play time including the speech segment.

13. The apparatus according to claim 7,
wherein said feature extraction unit identifies a face image from image data of the media data,
wherein said feature data storage unit stores face data including an identifier of the face image, a start time and an end time of a segment of the face image in the media data, and
wherein said play control display unit displays the feature figure representing the identifier in relation to a time figure of a play time including the segment.

14. The apparatus according to claim 7,
wherein said feature extraction unit detects a time of scene change from image data of the media data,
wherein said feature data storage unit stores the time of scene change, and
wherein said play control display unit displays the feature figure representing the scene change in relation to a time figure of a play time including the time of scene change.

15. The apparatus according to claim 7,
wherein, if the feature figure cannot be displayed in the time figure, said play control display unit displays a supplement area in relation to the time figure, and displays the feature figure in the supplement area.

16. The apparatus according to claim 1,
further comprising a media data obtainment unit configured to obtain the media data in recording order in real time.

17. The apparatus according to claim 16,
wherein said media data obtainment unit receives the media data as a data stream delivered from a media data delivery apparatus connected to a network.

18. The apparatus according to claim 1,
wherein said media data memory stores meta data of the media data, the meta data including feature data and a play time of a part including the feature data in the media data, and
wherein said control data display unit displays a feature figure representing the figure data in relation to a time figure of the play time.

19. A system comprising a media data play apparatus for playing media data and a remote control apparatus for controlling play of said media data play apparatus through a network, the media data being playable in time series and including at least one of speech data and video data,
said remote control apparatus comprising:
a play control display unit configured to display a plurality of time figures, each time figure corresponding to a play time of a part of the media data in time series order;
a data selection unit configured to select at least one time figure from the plurality of time figures through said play control display unit;
a play control unit configured to generate play control indication data that a play position is moved to a part of the play time corresponding to the at least one time figure in the media data; and
a communication unit configured to send the play control indication data to said media data play apparatus, and
said media data play apparatus comprising:
a communication unit configured to receive the play control indication data from said remote control apparatus; and
a play unit configured to play the media data from the part indicated by the play control indication data.

20. A computer program product, comprising:
a computer readable program code embodied in said product for causing a computer to play media data, said computer readable program code comprising:
a first program code to store media data in a memory, the media data being playable in time series and including at least one of speech data and image data;
a second program code to display a plurality of time figures on a display, each time figure corresponding to a play time of a part of the media data in time series order;
a third program code to select at least one time figure from the plurality of time figures on the display;
a fourth program code to move a play position to a part of the play time corresponding to the at least one time figure in the media data; and
a fifth program code to play the media data from the moved play position.

21. A computer program product, comprising:
a computer readable program code embodied in said product for causing a computer to remotely control play of media data in an apparatus through a network, said computer readable program code comprising:
a first program code to display a plurality of time figures on a display, each time figure corresponding to a play time of a part of the media data in time series order;
a second program code to select at least one time figure from the plurality of time figures through the display;
a third program code to generate play control indication data that a play position is moved to a part of the play time corresponding to the at least one time figure in the media data; and
a fourth program code to send the play control indication data to the apparatus through the network.

22. A computer program product, comprising:
a computer readable program code embodied in said product for causing a computer to play media data in response to an indication from a remote control apparatus through a network, said computer readable program code comprising:
a first program code to receive play control indication data from the remote control apparatus through the network, the play control indication data representing a part of the media data as a play position; and
a second program code to play the media data from the part represented by the play control indication data.
